(19) United States
(12) Patent Application Publication
(10) Pub. No.: US 2004/0039619 A1
(43) Pub. Date: Feb. 26, 2004

(54) Methods and apparatus for facilitating analysis of an organization

(76) Inventor: Joseph J. Zarb, Redding, CT (US)

Correspondence Address: BUCKLEY, MASCHOFF, TALWALKAR LLC, 5 ELM STREET, NEW CANAAN, CT, 06840, US

(21) Appl. No.: 10/226,484

(22) Filed: Aug. 23, 2002

(51) Int. Cl. G06F 17/60

(52) U.S. Cl. 705/7

(57) ABSTRACT

A system, method, apparatus, means, and computer program code for analyzing an organization. According to some embodiments of the present invention, a method for analyzing an organization may include allowing a user to select a benchmarking mode to analyze a organization, determine the information needed for the selected benchmarking mode, and provide information regarding the organization determined in accordance with the selected benchmarking organization. In some embodiments, information regarding the organization may include information regarding a strategy that may be implemented by the organization, a role associated with the strategy, a process associated with the role, and an asset associated with the process.

### FIELD OF THE INVENTION

The present invention relates to methods and apparatus for analyzing an organization and, more particularly, embodiments of the present invention relate to methods, means, apparatus, and computer program code for analyzing one or more strategies associated with the organization.

### BACKGROUND OF THE INVENTION

Companies often use various techniques to inventory or analyze their financial, physical and human resources in an effort to better optimize the allocation of these resources. Traditional methods provide specialized systems to inventory and allocate resources and other assets. For example, accounting systems inventory and allocate financial resources; customer relationship management systems inventory and allocate customer-related resources; human resource management systems inventory and allocate employee resources; and supply chain management systems inventory and allocate physical resources used for producing finished goods.

While such systems may provide a basis for understanding how assets are consumed, few, if any, provide the ability to project future consumption or use of the assets and none reveal how the consumption or use of these assets are inter-related through the normal course of business operations. Additionally, there is no systematic method for inventorying and forecasting business process improvements, particularly those enabled by information technology. Given this situation, company executives, project managers and employees lack the ability to forecast business process improvements and the related cost savings and revenue enhancements that such process improvements may create.

It would be advantageous to provide a method and apparatus that overcame the drawbacks of the prior art. In particular, it would be desirable to provide a system, methods, apparatus, means, and computer code for use in analyzing a strategy an organization may implement and the costs and benefits associated with the strategy. In addition, it would be desirable to provide a system, methods, means, and computer code for inventorying, analyzing and forecasting an organization's business processes and the cost and revenue impact of or change to physical, financial and human assets associated with the processes.

### SUMMARY OF THE INVENTION

Embodiments of the present invention provide a system, methods, apparatus, means, and computer program code for analyzing an organization. More specifically, according to some embodiments of the present invention, one or more business strategies may be identified that may produce short term and/or long term benefits to the organization. The strategies may be mapped to the roles within an organization tasked with or responsible for implementing them. In turn, the roles may be mapped to the processes performed by the roles to implement the strategies. In some embodiments, a process may be mapped directly to a strategy. Assets, which may be or include digital assets, physical assets, and/or collaborative assets, are then determined and associated with the different processes. From this a benefit of ownership provided by or associated with the assets, processes, roles, and strategies may be determined.

In addition to the benefit of ownership analysis, costs can be assigned to or otherwise associated with the assets and processes used to provide the benefits in such a way that different assets, processes, roles, and strategies can be analyzed and compared in conjunction with established or newly created benchmarking attributes and formulas. Thus, a cost of ownership of a strategy may be compared to a benefit of ownership associated with the strategy. In addition, improvements to an organization's business processes and the related physical, digital and/or collaborative assets can be forecasted and more effectively analyzed, measured and managed. Furthermore, the organization's willingness to undergo the proposed process transformation or to implement one or more of the strategies can be analyzed by department role or contribution to the proposed transformation.

Additional objects, advantages, and novel features of the invention shall be set forth in part in the description that follows, and in part will become apparent to those skilled in the art upon examination of the following or may be learned by the practice of the invention.

According to some embodiments of the present invention, a method for facilitating analysis of an organization may include determining a strategy associated with an organization; determining a benefit of ownership associated with the strategy, wherein the determining a total benefit of ownership associated with the strategy includes determining a role associated with the strategy, a process associated with the role, and at least one asset associated with the process; and determining a cost of ownership associated with the strategy. In some further embodiments, a method for facilitating analysis of an organization, comprising may include determining a strategy associated with an organization; and determining a benefit of ownership associated with the strategy, wherein the strategy has at least one associated process and the at least one associated process has at least one associated asset. In some other embodiments, a method for facilitating review of strategy associated with an organization may include determining a strategy associated with an organization; determining a plurality of people associated with the strategy; determining a first role for each of the plurality of people; and providing a set of at least one question regarding the strategy to each of the plurality of people. In some additional embodiments, a method for facilitating development of benchmark information regarding an organization may include allowing a user to select a benchmarking mode to analyze an organization; determining information needed for the benchmarking mode; and providing information regarding the organization determined as a result of implementing the benchmarking mode. In some further embodiments, a method for determining a benefit of ownership for a strategy may include determining a strategy associated with an organization; determining a process associated with the strategy; determining an asset associated with the process; and determining a target for at least one attribute of the asset. In some still further embodiments, a method for determining a benefit of ownership for a strategy may include determining a strategy associated with an organization; determining a role associated with the strategy; determining a process associated with the role; determining an asset associated with the process; and determining a target for at least one attribute of the asset.

According to some embodiments of the present invention, a system for facilitating analysis of an organization may include a memory; a communication port; and a processor connected to the memory and the communication port, the processor being operative to determine a strategy associated with an organization; and determine a benefit of ownership associated with the strategy, wherein the strategy has at least one associated process and the at least one associated process has at least one associated asset. In some other embodiments, a system for facilitating determination of a benefit of ownership of a strategy may include a memory; a communication port; and a processor connected to the memory and the communication port, the processor being operative to determine a strategy associated with an organization; determine a process associated with the strategy; determine an asset associated with the process; and determine a target for at least one attribute of the asset. In some other embodiments, different systems may include processors operative to implement the other methods described above.

According to some embodiments of the present invention, a computer program product in a computer readable medium for facilitating analysis of a strategy may include first instructions for identifying a strategy associated with an organization; and second instructions for identifying a benefit of ownership associated with the strategy, wherein the strategy has at least one associated process and the at least one associated process has at least one associated asset. In some other embodiments, a computer program product in a computer readable medium for facilitating determination of a benefit of ownership of a strategy may include first instructions for identifying a strategy associated with an organization; second instructions for identifying a process associated with the strategy; third instructions for identifying an asset associated with the process; and fourth instructions for identifying a target for at least one attribute of the asset. In some additional embodiments, a computer program product in a computer readable medium for facilitating development of benchmark information regarding an organization may include first instructions for facilitating selection of a benchmarking mode to analyze an organization; second instructions for identifying information needed for the benchmarking mode; and third instructions for sending information regarding the organization determined as a result of implementing the benchmarking mode. In some further embodiments, a computer program product in a computer readable medium for facilitating review of strategy associated with an organization may include first instructions for identifying a strategy associated with an organization; second instructions for identifying a plurality of people associated with the strategy; third instructions for identifying a first role for each of the plurality of people; and fourth instructions for sending a set of at least one question regarding the strategy to each of the plurality of people.

According to some embodiments of the present invention, an apparatus for facilitating analysis of a strategy may include means for identifying a strategy associated with an organization; and means for identifying a benefit of ownership associated with the strategy, wherein the strategy has at least one associated process and the at least one associated process has at least one associated asset. In some other embodiments, an apparatus for facilitating determination of a benefit of ownership of a strategy may include means for identifying a strategy associated with an organization; means for identifying a process associated with the strategy; means for identifying an asset associated with the process; and means for identifying a target for at least one attribute of the asset. In some additional embodiments, an apparatus for facilitating development of benchmark information regarding an organization may include means for facilitating selection of a benchmarking mode to analyze an organization; means for identifying information needed for the benchmarking mode; and means for sending information regarding the organization determined as a result of implementing the benchmarking mode. In some further embodiments, an apparatus for facilitating review of strategy associated with an organization may include means for identifying a strategy associated with an organization; means for identifying a plurality of people associated with the strategy; means for identifying a first role for each of the plurality of people; and means for sending a set of at least one question regarding the strategy to each of the plurality of people.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is an illustration of a table that may be used in the determine at least one strategy step of FIG. 1;

FIG. 3 is another illustration of a table that may be used in the determine at least one strategy step of FIG. 1;

FIG. 4 is another illustration of a table that may be used in the determine at least one strategy step of FIG. 1;

FIG. 5 is a flowchart of a possible implementation of the determine at least one strategy step of FIG. 1;

FIG. 6 is an illustration of an interface for use in obtaining strategy information in accordance with some embodiments of the present invention and may be used as part of the determine at least one strategy step of FIG. 1;

FIG. 7 is a flowchart of a possible implementation of the determine benefit of ownership step of FIG. 1;

FIG. 8 is a flowchart of a possible implementation of the determine information needed for the select benchmarking mode step of FIG. 7;

FIG. 9 is a representative illustration of relationships between roles, processes, and assets for a strategy that may result from the implementation of FIG. 8;

FIG. 10 is an illustration of an interface for use in obtaining role information in accordance with some embodiments of the determine a role step of FIG. 8;

FIGS. 11, 12, and 13 are an illustration of tables that may be used in an interface for use with some embodiments of the determine a process step of FIG. 8;

FIG. 14 is an illustration of a table indicating phasing in of benefits from the process described in the FIGS. 11-13;

FIGS. 15, 16, and 17 are an illustration of tables that may be used in an interface for use in some embodiments of the determine an asset step of FIG. 8 where information regarding a digital asset is determined;

FIG. 18 is an illustration of a table indicating phasing in of benefits from the digital asset described in the FIGS. 15-17;

FIGS. 19, 20, and 21 are an illustration of tables that may be used in an interface for use in some embodiments of the determine an asset step of FIG. 8 where information regarding a physical asset is determined;

FIG. 22 is an illustration of a table indicating phasing in of benefits from the physical asset described in the FIGS. 19-21;

FIGS. 23, 24, and 25 are another illustration of tables that may be used in an interface for use in some embodiments of the determine an asset step of FIG. 8 where information regarding a physical asset is determined;

FIG. 26 is an illustration of a table indicating phasing in of benefits from the physical asset described in the FIGS. 23-25;

FIGS. 27, 28, and 29 are an illustration of tables that may be used in an interface for use in some embodiments of the determine an asset step of FIG. 8 where information regarding a collaborative asset is determined;

FIG. 30 is an illustration of a table indicating phasing in of benefits from the physical asset described in the FIGS. 27-29;

FIGS. 31, 32, and 33 are another illustration of tables that may be used in an interface for use in some embodiments of the determine an asset step of FIG. 8 where information regarding a physical asset is determined;

FIG. 34 is an illustration of a table indicating phasing in of benefits from the physical asset described in the FIGS. 31-33;

FIG. 35 is a block diagram of components in a system that may implement the methods of the present invention; and

FIG. 36 is a block diagram of components of one embodiment of the analysis device of FIG. 35.

### DETAILED DESCRIPTION

Applicant has recognized that there is a market opportunity for systems, means, methods, and computer code that facilitate analysis of an organization. More specifically, applicant has recognized that there is a need for systems, means, methods, and computer code for determining one or more business strategies that may produce short term and/or long term benefits to the organization. Each of the strategies may be mapped to or associated with one or more roles within the organization tasked with implementing them. In turn, each of the roles may be mapped to or associated with one or more processes performed by the roles to implement the strategies. Assets, which may be or include digital assets, physical assets, and/or collaborative assets, may then be determined and related to the different processes. From this a benefit of ownership provided by or associated with the strategies may be determined by analysis of processes, roles and assets associated with the strategies. Benefits of ownership associated with a strategy may include cost savings or cost avoidance and/or revenue enhancements. A total benefit of ownership for a strategy may be looked at or determined as conservative, probable, or assertive and the benefit may be obtained or phased in over time.

In addition to the benefit of ownership analysis, costs can be assigned to or otherwise associated with the assets and processes used to provide the benefits in such a way that different assets, processes and strategies can be analyzed and compared in conjunction with established or newly created benchmarking attributes and formulas. Thus, a total cost of ownership (TCO) of a strategy may be compared to a total benefit of ownership (TBO) associated with the strategy. In addition, improvements to an organization's business processes used for a strategy and the related physical, digital and/or collaborative assets involved with the strategy can be forecasted and more effectively analyzed, measured and managed. Furthermore, different employees within the organization may have different responsibilities in the organization or different relationships with a strategy or opinions regarding the strategy. The different employees within the organization can be queried to determine their opinions and thoughts regarding a strategy and/or the benefits of ownership and/or costs of ownership associated with the strategy. In addition, such evaluation of or by the employees may indicate the employees' willingness to implement a strategy as well as their concerns regarding the strategy and the assumptions underlying the strategy.

In some embodiments, a cost of ownership for a strategy may be expressed by phase. Phases might include evaluation, acquisition, implementation, operational usage, maintenance, etc. A cost of ownership may be looked at or determined as conservative, probable, or assertive. By allocating costs for process and assets for a strategy for each phase of the strategy, the cost of ownership for the strategy can be determined.

As will be discussed in more detail below, the present invention allows one or more strategies for an organization to be identified and analyzed. Analysis of a strategy may include determining a benefit of ownership associated with the strategy in according with a benchmarking mode. A benchmarking mode may include different formulas and attributes useful in measuring or comparing different aspects of the organization or different strategies. For example, a strategy may have multiple processes and assets associated with it. A benchmarking mode may be used to analyze each process and asset in a consistent manner using formulas and attributes associated with the benchmarking mode. The benefit of ownership for each process and asset can then be used to determine the benefit of ownership for the overall strategy and/or a role associated with the strategy.

A benchmarking mode may include analyzing different types of assets associated with a strategy. For example, as will be discussed in more detail below, the present invention facilitates analysis of an organization and enables association of one or more strategies with one or more processes and one or more assets. Assets may include physical assets (e.g., buildings, computers, telephones, file cabinets, desks), digital assets (e.g., software packages, internet websites, syndicated data), and collaborative assets (e.g., customers, suppliers, distributors or outsourced personnel). Assets may be associated with, or analyzed in accordance with, benchmarking formulas or attributes. In some embodiments an asset may be related to one or more strategy and a strategy may have one or more associated assets. In addition, the benefit of ownership and/or the cost of ownership associated with a strategy may change over time as business conditions or needs change, attributes and formulas used in benchmarking modes change or are refined, or more accurate information becomes known with regard to a process or asset. These and other features will be discussed in further detail below, by describing a system, individual devices, and processes according to embodiments of the invention.

Process Description

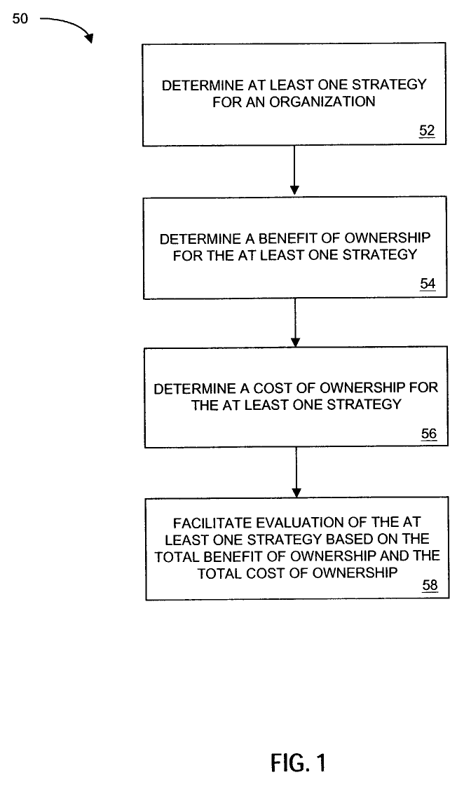

Reference is now made to FIG. 1, where a flow chart 50 is shown that represents operation of a first embodiment of the present invention. The particular arrangement of elements in the flow chart 50 is not meant to imply a fixed order to the steps; embodiments of the present invention can be practiced in any order that is practicable. In some embodiments, the method 50 may be implemented in software operating on a user device (e.g., computer, personal digital assistant) or operating on a device (e.g., a Web site server) that is accessible by the user device (e.g., via the World Wide Web).

Processing begins at a step 52 during which at least one strategy for an organization is identified or otherwise determined. During a step 54, a benefit of ownership for the at least one strategy is identified or otherwise determined and during a step 56 a cost of ownership for the at least one strategy is identified or otherwise determined. During a step 58, the at least one strategy is evaluated based on the benefit of ownership determined during the step 54 and the cost of ownership determined during the step 56. In some embodiments the sep 56 may occur before the step 54 or simultaneously with the step 54. Each of the steps 52, 54, 56, and 58 are discussed in more detail below.

Determining a Strategy

In some embodiments, one or more strategies associated with an organization might be determined during the step 52. In addition, a strategy may be obtained from a user (e.g., the user is allowed to enter, identify, or select one or more strategies) or determined in a more automated fashion. For example, a user may want to compare a company (i.e., an organization) to one or more other companies regarding certain criteria. The criteria might be selected by the user or designated or selected in advance by a device or software implementing the step 52. Criteria might include such things as revenue growth, gross margin, the amount of sales per employee, etc. The criteria may be associated with a time period (e.g., quarter, year, five years).

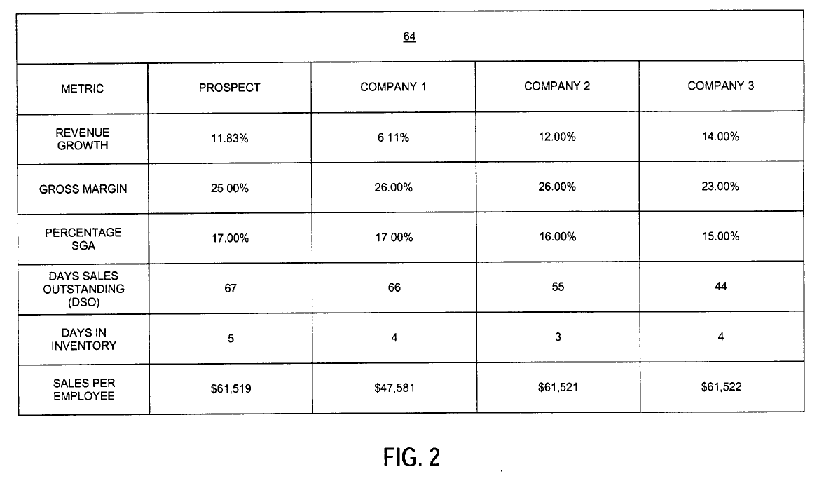

Now referring to FIG. 2, table 64 is a representative illustration of a technique that may be used as part of the step 52 of determining at least one strategy. The table 64 illustrates how a user may compare a prospect company with three other companies identified as “Comp. 1”, “Comp. 2” and “Comp. 3” with regards to the criteria of revenue growth, gross margin, percent sales general administration (% SGA), days sales outstanding (DSO), days in inventory, and sales per employee. The comparisons may help the user select or identify a strategy for the prospect company as part of the step 52. In other embodiments, other criteria for comparing different companies may be used and the user may be able to select or designate the criteria. For example, a user or device analyzing the table 64 may conclude that the prospect company should attempt to reduce its DSO of sixty-seven days.

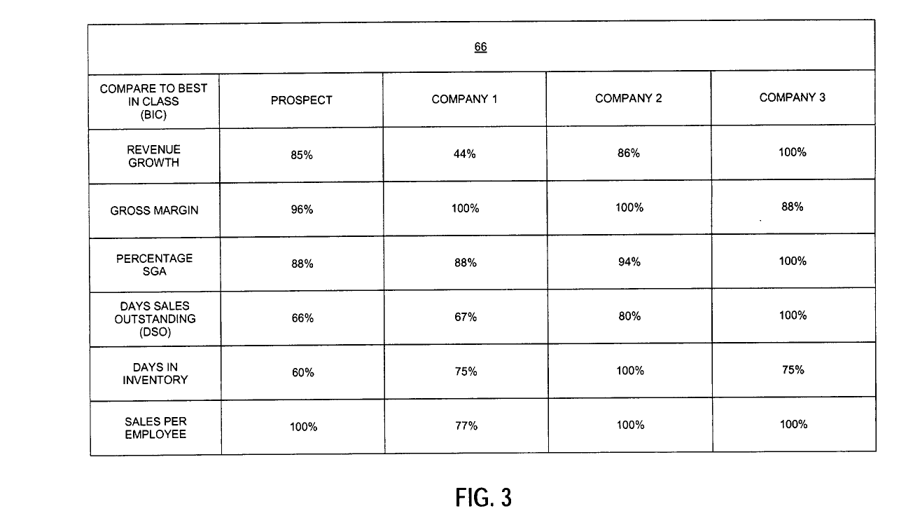

Now referring to FIG. 3, table 66 provides a comparison of the criteria for the prospect company versus the best-in-class based on the prospect company and the three other companies may be used to highlight strengths and weaknesses of the prospect company relative to the other three companies. A best-in-class analysis can provide an analysis of financial or other metrics which compare and contrast multiple companies across a series of objectives to determine which company is performing the best, which company is performing the weakest, and what the relative value of improving operations across one or all of the metrics may yield. Such benchmarking provides a framework for determining realistic strategies and goals that are achievable based on competitive analysis and realities. Additionally, such analysis may provide insight into the strategies and focus of competitors. For example a company that has a strong revenue growth dimension (metric/benchmark) and a poor sales per employee dimension (metric/benchmark) may indicate a need or opportunity for an investment in sales professionals to drive revenue growth and market share by improving the sales per employee.

In some embodiments, a device may store or have the information regarding the criteria for the prospect company and/or the other three companies. Alternatively, the device may request the information from a user, retrieve the information from an information source (e.g., a database, external feed via the internet, a supplemental digital media (CD ROM, 8 mm tape, etc.)), or otherwise obtain the information for the prospect company and/or the other three companies.

As illustrated in the tables 64 and 66, the prospect company had 11.83 percent revenue growth during the period analyzed (typically one or more years), which is eighty-five percent of the best-in-class company (i.e., Comp. 3) for the revenue growth criterion. Similarly, the prospect company had gross margins of twenty-five percent during this time period, which is ninety-six percent of the gross margins for the two companies considered best-in-class for this criterion (i.e., Comp. 1 and Comp. 2).

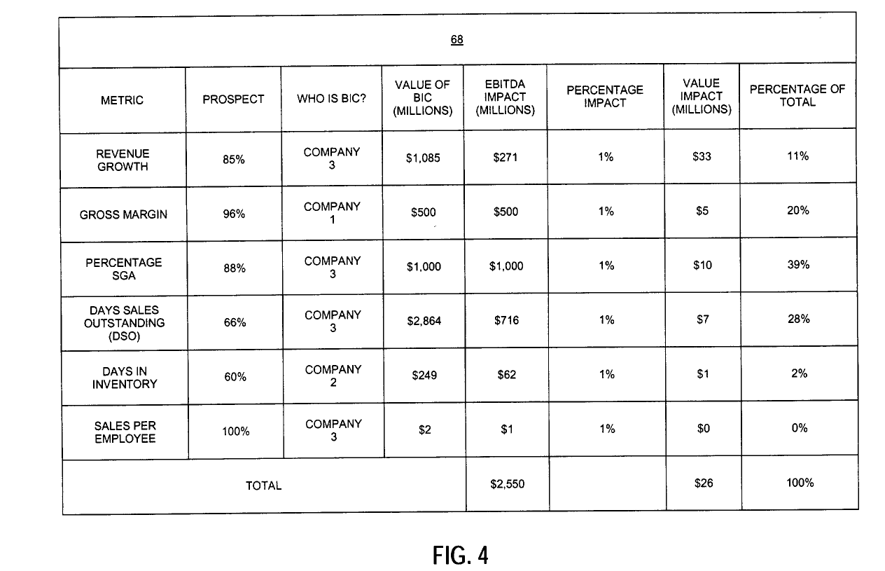

Now referring to FIG. 4, table 68 provides information derived from the information in FIG. 2 and other information regarding the prospect company and the three other companies. As illustrated in FIG. 4, the best-in-class with regard to the criterion “REVENUE GROWTH” is “Comp. 3” and the value of the best-in-class with regard to the prospect company for the criterion “REVENUE GROWTH” is $1,085,000,000, which may be derived or otherwise obtained from a company's annual report or 10K filing, and is a measure of the revenue growth potential for the prospect company if it were to achieve the level of revenue growth that the best-in-class company set as the upper limit. The impact of earnings, before interest, taxes, depreciation, and amortization (EBITDA) of $271,000,000 (e.g., $271,000,000=((Best in Class Revenue Growth Percentage−the prospect Revenue Growth Percentage)×the prospects Revenue from their annual report or 10K filing)×the prospects gross margin percentage) or ((14%-11.83%)×$50,000)×25%) can be extrapolated from the value of the best-in-class times the prospect company's gross profit margin and is a measure of the revenue growth potential for the prospect company taking into account the costs of sales if the prospect company were to achieve the level of growth that the best-in-class company set as an upper limit. A one percent impact in revenue growth provides a value impact of $2,860,000.00 or approximately $3,000,000, which is a measure of the revenue impact and is approximately eleven percent of the overall total value impact (i.e., eleven percent of $26,000,000). Similar evaluations are illustrated for the other comparison criteria.

As illustrated in the table 68, the results of a one percent improvement in the sales per employee criterion will result in a zero dollar value impact since the prospect is the best-in-class company for this criterion.

In some embodiments, a strategy might be taken that provides the best overall improvement. For the present example, a strategy might automatically be determined or selected as “IMPROVE SALES PER EMPLOYEE”. However, as the prospect company already is the best-in-class with regard to the sales per employee criterion, in some embodiments another criterion might be selected automatically to form the basis of a strategy where the strategy has the biggest potential gain (e.g., “IMPROVE GROSS MARGIN”) or the area that provides the biggest opportunity for improvement with respect to best-in-class (e.g., “IMPROVE DAYS SALES OUTSTANDING”).

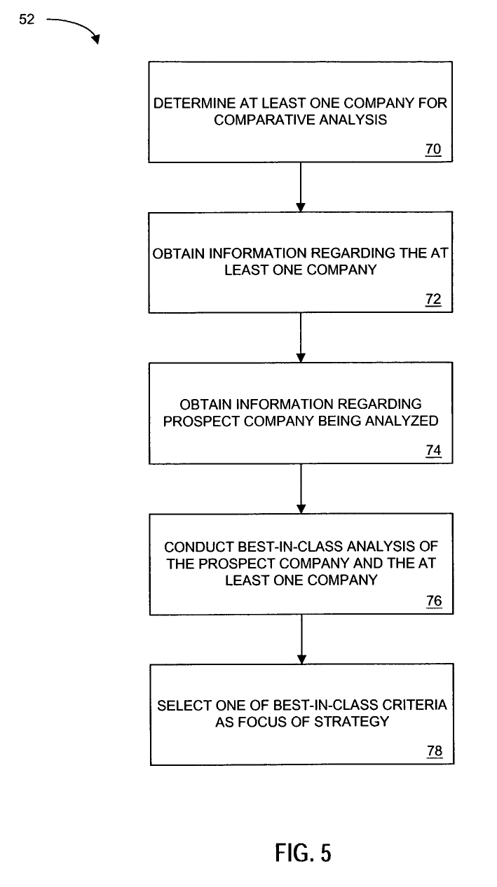

Now referring to FIG. 5, a flowchart is represented that may represent one embodiment of the step 52 of determining at least one strategy. The step 52 may include a step 70 during which at least one company or other organization is identified or otherwise determined that will be analyzed. In some embodiments, the at least one company may be identified by name, stock ticker symbol, address, tax identification number or some other form of identifier. For example, an organization determined during the step 70 may be or include the companies identified as “Comp. 1”, “Comp. 2” and/or “Comp. 3” and previously discussed above in relation to FIGS. 2-4. In some embodiments, a device or software implementing the step 70 may query or prompt a user to provide or enter a name of a company or other organization, receive instructions to analyze a particular company or other organization, etc.

During a step 72, information regarding the organization identified during the step 72 may be retrieved, located or otherwise obtained or determined. For example, the information may be or include the information discussed in conjunction with FIGS. 2-4 above (e.g., gross sales, days sales outstanding). In some embodiments, information for one or more organizations may come from different information sources. In some embodiments, some or all of the information regarding an organization be entered by a user, be retrieved from a database, or come from some other source. In some embodiments, software or a device implementing the step 72 may prompt or query a user to provide some or all of the information or the metric of interest to the user. In some embodiments, the step 72 might be combined with the step 70.

During a step 74, information regarding a prospect company or other organization also may be retrieved, located or otherwise obtained or determined. In some embodiments, the step 74 may occur prior to the step 70 and/or the step 72. In some embodiments, the step 74 may include identifying or otherwise determining the prospect company or other organization. In some embodiments, the prospect company or other organization may be identified by name, stock ticker symbol, address, tax identification number or some other form of identifier. In some embodiments, a device or software implementing the step 74 may query or prompt a user to provide or enter a name of a company or other organization, receive instructions to analyze a particular company or other organization, receive information regarding the metric of interest to the user, etc.

During a step 76, a best-in-class analysis is conducted regarding the prospect organization and the at least one other organization. For example, a best-in-class analysis may be conducted as described above in relation to FIGS. 2-4. The best-in-class analysis may be based on the information determined during the steps 72, 74 or some other criteria or attributes selected or indicated by a user.

During a step 78, one of the best-in-class criteria is selected and used to form the focus or basis of a strategy, as previously discussed above. For example, a strategy which targets increasing revenue growth may be selected as a one percent positive impact would equate to thirty-three million dollars or an eleven percent improvement over current business operations. Additionally, a one percent improvement in SGA would yield a lesser value impact at ten million dollars, but would improve business operations by thirty-nine percent. Targeting either or both of these metrics may provide a foundation to base a business strategy upon for an organization.

In some embodiments, a strategy may be determined by receiving, retrieving, or otherwise acquiring information regarding the strategy. For example, a device or software application implementing the step 52 may retrieve the strategy information from a database, receive the strategy information as part of an electronic communication (e.g., email message, FTP or XML transmission) or database query, etc.

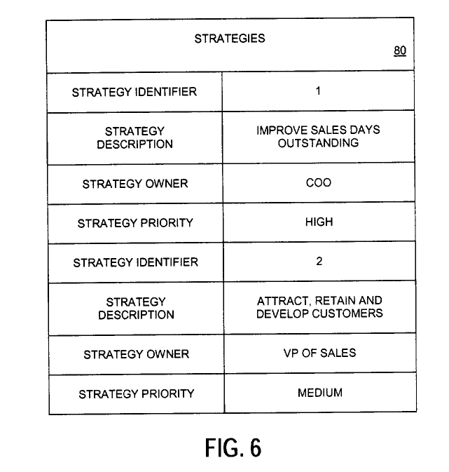

Now referring to FIG. 6, in some embodiments the step 52 may be implemented via an interface or dashboard that allows a user to identify, select, or enter one or more strategies or otherwise provide or enter information regarding one or more strategies. The interface may be provided or implemented via a browser or other software operating on a user device (e.g., laptop computer, personal digital assistant, workstation) or provided via a Web site. For example, an interface or table 80 as illustrated in FIG. 6 may allow a user to enter one or more strategies and provide information regarding the strategies. The interface or table 80 may be displayed by software operating on a user device. As illustrated in the table 80, a strategy of “IMPROVE DAYS SALES OUTSTANDING” has been entered and the strategy has an associated strategy identifier of “1”. In some embodiments, a strategy may have an associated owner. An owner of a strategy may be someone who is responsible for establishing, monitoring, analyzing, and reporting on the financial and operational impact of the strategy or otherwise managing the strategy. In some embodiments, a strategy may have an associated priority level. A priority level of a strategy is an indicator of the criticality to the strategy to an organization, a specific project that includes the strategy, etc. and may be a reflection of the importance or need that the strategy meet or exceed projected financial or operational improvements or guidelines.

As illustrated in the table 80, the strategy of “IMPROVE DAYS SALES OUTSTANDING” has a “HIGH” priority and an associated owner (i.e., “COO”). Another strategy of “ATTRACT, RETAIN AND DEVELOP CUSTOMERS” also is entered in the table 80 and has an associated priority of “MEDIUM”, an associated owner “VP OF SALES”, and an associated strategy identifier of “2”

Determining a Benefit of Ownership for a Strategy

In some embodiments, determining a benefit of ownership may include aligning corporate strategies and department roles with business processes. For each of the business processes further alignment may be modeled depicting how physical, digital and collaborative assets are consumed or created by the associated business process. As the business process throughput characteristics are changed, the related consumption and creation of assets will also change. The resulting model provides an alignment of assets consumed by business processes, for a department role that support a given strategy.

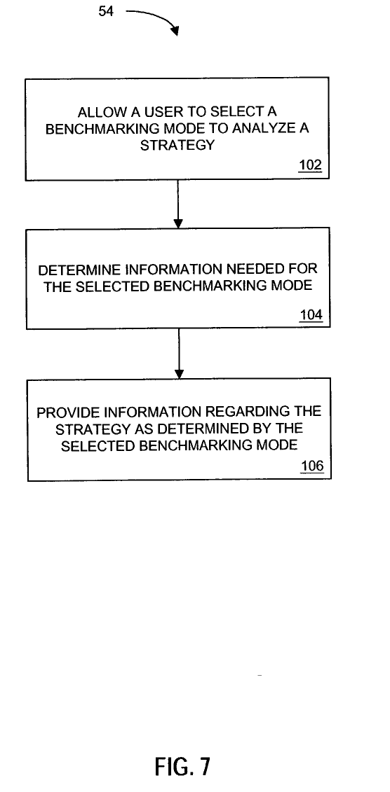

Reference is now made to FIG. 7, where a flow chart is shown which represents the operation of a first embodiment of the determine a benefit of ownership step 54 in the method 50 of FIG. 1. In some embodiments, the step 54 may be implemented in software operating on a user device (e.g., computer, personal digital assistant) or operating on a device (e.g., a Web site server) that is accessible by the user device (e.g., via the World Wide Web).

Determining a benefit of ownership may entail aligning a corporate strategy with related department roles and business processes. For each business process, further alignment may be modeled depicting how physical, digital and collaborative assets are consumed or created by the business process. As throughput characteristics for the business process are changed, related consumption and creation of assets related to the business process also may change. The resulting model provides an alignment of assets consumed by the business process for a department role that supports the corporate strategy.

Processing begins at a step 102 during which a user is allowed to select or otherwise establish a benchmarking mode to analyze a strategy. In some embodiments, there may be multiple benchmarking modes that may be allowable or selectable, each of which may use different sets or templates attributes and formulas. For example, a user may be able to select a benchmarking mode from a library or database of previously created benchmarking modes, each of which has associated attributes and formulas that may form a template for the benchmarking mode. Alternatively, the user may be able or allowed to create a new benchmarking mode by providing attribute and formula information for the new benchmarking mode. The attribute and formula information may form a template for the benchmarking mode. As a third example, the user may be able to select a default benchmarking mode which may have an associated set or template of attributes and formulas. In some embodiments, a user may be a human or an automated computer or other system.

In general, a benchmarking mode may have an associated set of one or more formulas and/or one or more attributes used to analyze processes and assets in relation to one or more particular strategies. Different attributes and/or formulas may be used for different processes and different types of assets, as will be discussed in more detail below. Thus, selecting a benchmarking mode from a library of benchmarking modes may include selecting a set of predetermined or predefined formulas and/or attributes for use in the analysis of a strategy, role, process or asset. Creating a new benchmarking mode may include establishing one or more formulas and/or attributes for use in the analysis. Once a new benchmarking mode is created, it can be added to the library for later use or selection. A default benchmarking mode may include a set of predetermined or predefined formulas and/or attributes and may be one of the benchmarking modes included in the library of benchmarking modes. Further information regarding, and examples of, benchmarking modes is provided below.

During a step 104, information is determined that is needed for the benchmarking mode selected during the step 102 for analysis of a strategy. In some embodiments, the information may be retrieved from a database of information previously created or, obtained regarding the company. In other embodiments, the information may be obtained from the user that selected the benchmarking mode during the step 102. Further information regarding the step 104 is provided below.

During a step 106, information is provided regarding the strategy based on the benchmarking mode selected during the step 102 and the information determined during the step 104. In some embodiments, information may be provided in one or more reports or designated formats. In addition, the user may be able to select or indicate desired reports, formats, etc. in which to receive the information. The information provided during the step 106 may include information regarding the benefit of ownership associated with one or more strategies.

In some embodiments, the information provided during the step 106 may be provided electronically or in digital format. For example, the information may be provided in, or as part of, an instant message communication, an email message, and XML or FTP transmission, a Web page or Web site display, a file attachment, etc. Further information and examples of the step 106 are provided below.

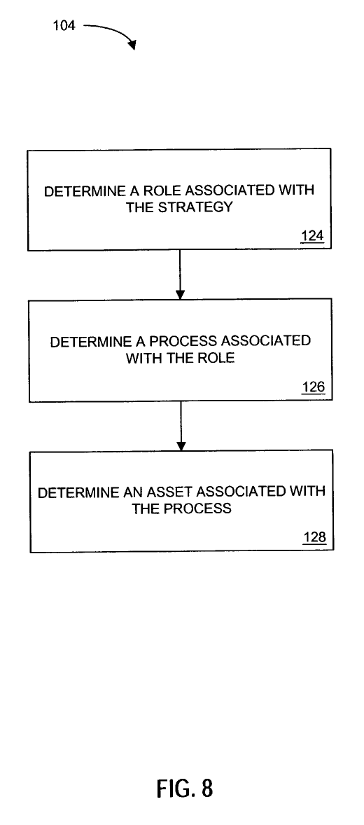

Reference is now made to FIG. 8, where a flow chart is shown which represents further detail regarding the step 104 of the step 54 in regard to the strategy determined during the step 52. As previously discussed above, a strategy determined during the step 52 may involve many different kinds of activities that an organization might want to take, be forced to take, is considering taking, etc. For example, an organization may want to improve its sales of products internationally, increase production, reduce the days in inventory of its goods, improve its days sales outstanding (i.e., operational efficiency of core business processes), improve the return on its marketing expenditures, improves its sales per employee, profit margin, etc. A strategy can be formulated broadly or narrowly and may be determined automatically.

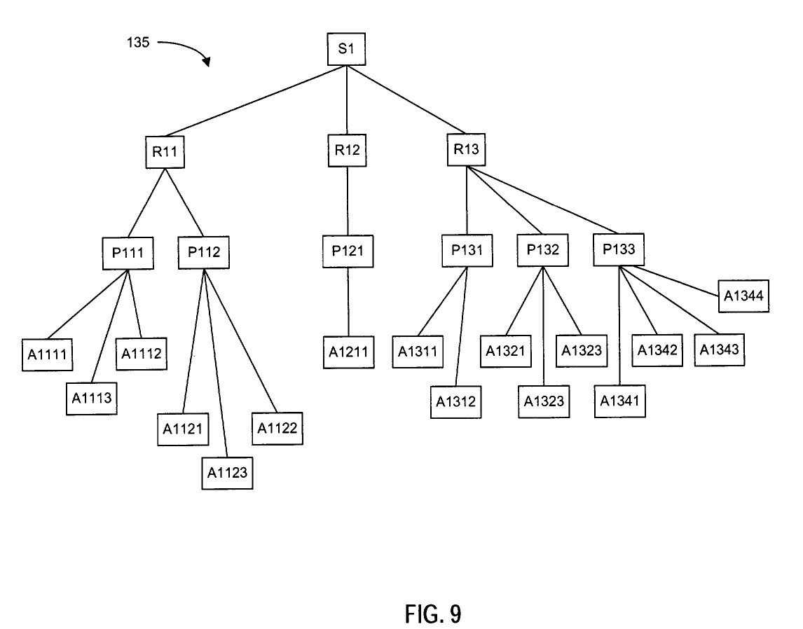

As will be discussed in more detail below, in some embodiments a strategy may have more than one associated role and each role may have one or more associated processes. In addition, each of the processes may have one or more associated assets. Now referring to FIG. 9, a model or tree 135 illustrating relationships between a strategy and associated roles, processes and asset is illustrated. In this example, a typical strategy labeled “S1” may have many associated roles, processes, and assets. For example, the strategy labeled as “S1” has three roles “R11”, “R12” and “R13” associated with it. Each of the roles “R11”, “R12” and “R13” may have one or more associated processes. For example, the role labeled “R11” has two associated processes “P111” and “P112” while the role labeled “R12” has only one associated process “P121”. Each process may have one or more assets associated with it. For example, the process “P111” has three associated assets “A111”, “A1112” and “A1113”. Similarly, the process “P112” has three associated assets “A1121”, “A1122” and “A1123”. The step 104 includes determining at least one role for a strategy, at least one process associated with the role, and at least one asset associated with the process.

Referring once again to FIG. 8, during a step 124, at least one role is determined for at least one of the strategies determined during the step 52. In some embodiments, one or more roles may be determined for some or all of the strategies determined during the step 52. There is no limit to the number of roles that may be encompassed by a single strategy. As one example, a role for the strategy “IMPROVE DAYS SALES OUTSTANDING” may be or include “SALES DEPARTMENT”.

In some embodiments, a role will fall within the purview of a department or other organized group of personal within an organization. In some embodiments, a role may have an associated total headcount that may indicate the number of people within the department or organized group. In some embodiments, a role may have an associated funding percentage for the department or group that may relate the percentage of the total funding for the group or department that may be applicable to the role's associated strategy. Thus, a “percentage of funding from a department for a strategy” is a measure of the financial contribution made by the department to support a new project or initiative in support of the entered strategy. A total department headcount for a department is a count of the total number of people within the department who occupy the given role.

In some embodiments, a role may have an associated figure indicative of the fully loaded cost of the headcount entry (per person). For example, a fully loaded cost of headcount from department may include the employee salary plus burden (insurance, training costs, bonuses and awards) as an average amount per employee for the department.

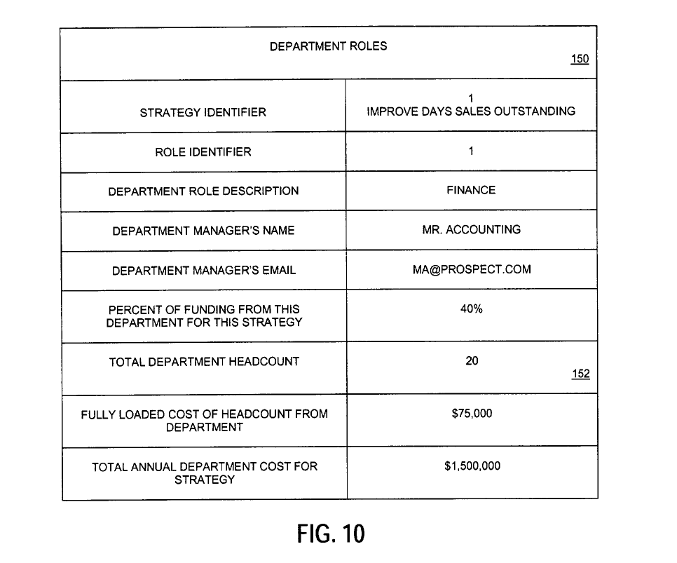

In some embodiments, the step 124 may be implemented via an interface that allows a user to identify or enter one or more roles and associate them with one or more strategies determined during the step 122. For example, an interface or table 150 as illustrated in FIG. 10 may allow a user to enter or identify one or more roles relative to the strategy “IMPROVE DAYS SALES OUTSTANDING” determined during the step 124 and provide information related to one or more roles for the strategy “IMPROVE DAYS SALES OUTSTANDING”.

As illustrated in the interface or table 150, a department role of “FINANCE” is associated with the strategy “IMPROVE DAYS SALES OUTSTANDING”. The role “FINANCE” has a total department headcount of twenty people (see entry 152) and a fully loaded cost of headcount from the department of $75,000 (see entry 153). Thus, an annual recurring cost of $1,500,000 for this department is required to support the associated strategy “IMPROVE DAYS SALES OUTSTANDING”. Also as illustrated in the table 150, the role “FINANCE” has a role identifier of “1” and a percentage of funding from department for the strategy of forty percent (40%), which means that this role will contribute forty percent (40%) of the budget or cost required to implement the associated strategy “IMPROVE DAYS SALES OUTSTANDING”. As illustrated in the table 150, the total annual department cost for the strategy “IMPROVE DAYS SALES OUTSTANDING” and the role “FINANCE” is $1,500,000, which is equal to the total headcount number (i.e., twenty) times the fully loaded cost of headcount from department number (i.e., $75,000). The table 150 also reflects that the manager's name associated with the department role “FINANCE” is “MR. ACCOUNTING” and that the manager is associated with the email address “MA@.PROSPECT.COM”.

While the table 150 illustrates information provided for the role “FINANCE” for the strategy “IMPROVE DAYS SALES OUTSTANDING”, other roles also may be entered for this role and strategy in a similar manner. In addition, the interface also may be used to enter information for the strategy “ATTRACT, RETAIN AND DEVELOP CUSTOMERS”.

Referring once again to FIG. 8, during a step 126, at least one process is determined for at least one of the roles determined during the step 124. As a result, the at least one process is associated with the strategy determined during the step 124. In some embodiments, a process may be associated directly with a strategy without being first associated with a role. Thus, the step 124 may not be necessary in all embodiments of the present invention.

In some embodiments, one or more processes may be determined for some or all of the roles determined during the step 124. There is no limit to the number of processes that may be encompassed by or related to a single role. A process may be or include and business task or decision such as “INVOICE COLLECTION” or “DETERMINE TARGET AUDIENCE” and may be related to more than one role and/or strategy. In some embodiments, a business process may be any broad collection of activities within a company that is involved in the ultimate goal of developing or providing a product or service to a customer in support of an associated strategy.

In some embodiments, the identification of a process during the step 126 may include gathering additional information regarding attributes of the process such as, for example: (1) the number of people for or within the role that perform the process; (2) the number of people it takes to perform one instance of the process; (3) the percentage of the role's fully loaded headcount time that is dedicated to the process; (4) the number of full time equivalent employees (FTEs) that perform the process; (5) the number of instances of the process that are performed in a given time period or time or instance interval; and (6) the time on average it takes to complete one instance of the process. These attributes provide the needed variables to understand productivity and forecast throughput improvements.

In addition to the information provided above, in some embodiments the step 126 may include obtain target information regarding a process. For example, the step 126 may include obtaining conservative, probable and/or assertive actual estimates or percentage estimates for different aspects of the process for use in evaluating the process. Actual or percentage targets may reflect changes to throughput characteristics of a given process. Such characteristics may include: number of people involved in the process, percentage of time dedicated by the headcount to the process, time interval of a single process execution, number of process instances achievable for the interval as well as other attributes which describe the dynamics of the consumption of time and people as related to a process cycle.

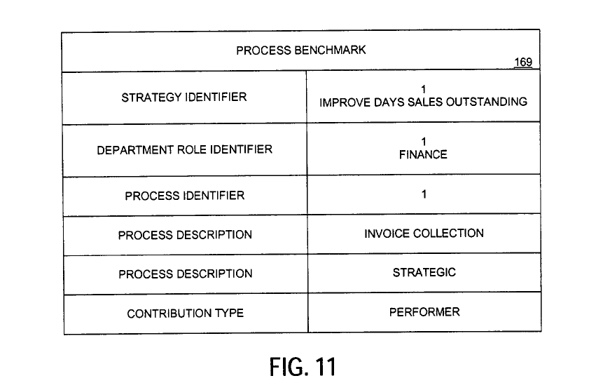

In some embodiments, the step 126 may be implemented via an interface that allows a user to identify or enter one or more processes and associate them with one or more of the roles determined during the step 124. The interface may be provided or implemented via a browser or other software operating on a user device or provided via a Web site. For example, an interface or table 169 as illustrated in FIG. 11 may allow a user to identify or enter one or more processes related to the role “FINANCE” for the strategy “IMPROVE DAYS SALES OUTSTANDING” and/or enter or provide information regarding one or more processes related to the role “FINANCE” for the strategy “IMPROVE DAYS SALES OUTSTANDING”.

As illustrated in the table 169, a process of “INVOICE COLLECTION” is associated with the role of “FINANCE” that is, in turn, associated with the strategy “IMPROVE DAYS SALES OUTSTANDING”. The process “INVOICE COLLECTION” has a process identifier of “1” and is considered “STRATEGIC”, which is a measure of the processes' visibility and importance to management. In some embodiments a process may be tagged either as “strategic” or “tactical”, which is a reflection of the importance or relationship of the process to the strategy. In addition, the process “INVOICE COLLECTION” has an associated contribution type of “PERFORMER”, which is an indication of the associated role's contribution to the process. In some embodiments, valid contribution types may include, but are not limited to originator, performer, contributor, reviewer and approver

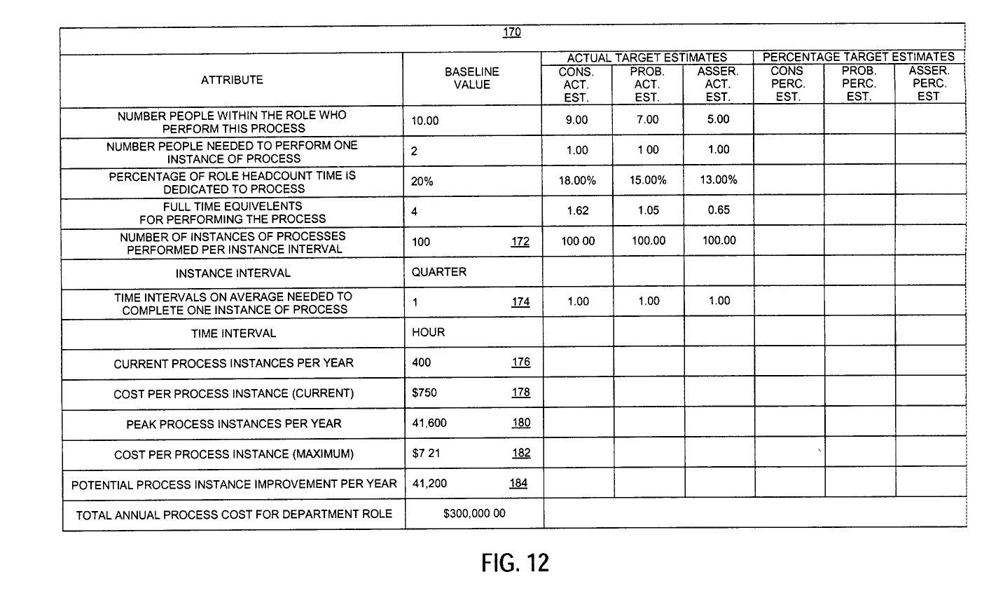

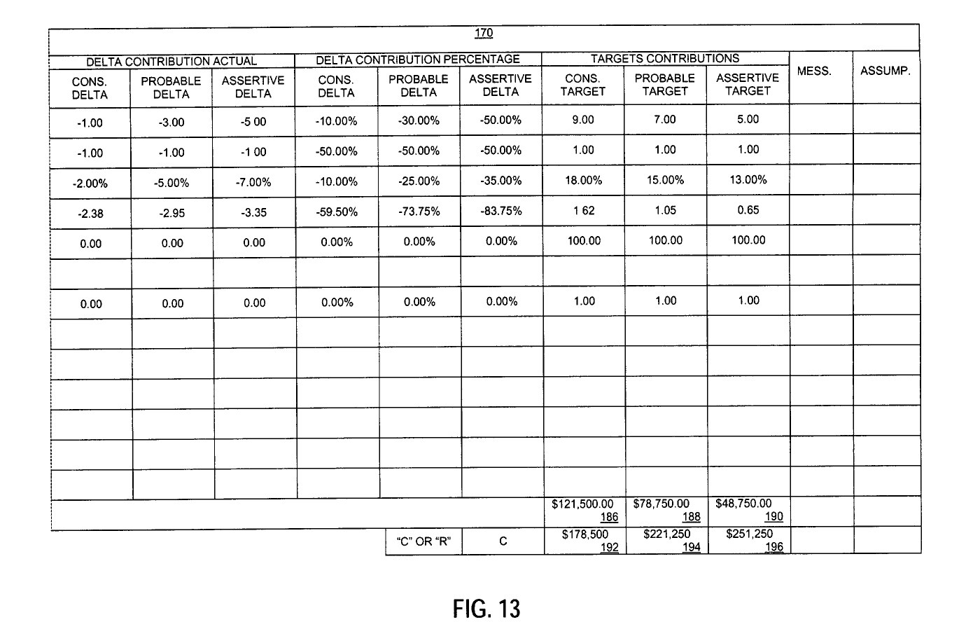

In addition to the table 169, an interface used in or for the step 126 also may include a table 170 as illustrated in FIGS. 12 and 13 that allows a user to provide or enter information associated with the process “INVOICE COLLECTION”. For example, as illustrated in the table 170, the process “INVOICE COLLECTION” has ten people within the role “FINANCE” that perform the process “INVOICE COLLECTION” and it takes two of the people to perform one instance of the process “INVOICE COLLECTION.” The percentage of the role's total fully loaded headcount's time that is dedicated to this process is twenty percent (20%). The number of FTEs dedicated to performing this process is computed or entered as four. One hundred instances of the process “INVOICE COLLECTION” are performed per quarter and it takes, on average, one hour to complete each instance of the process “INVOICE COLLECTION”.

The attributes and formulas used in the table 170 are associated with the benchmarking mode selected during the step 102. A different benchmarking mode may use different attributes and formulas for analyzing the process “INVOICE COLLECTION”.

Also as illustrated in the table 170 in FIG. 12, several attributes can be computed regarding the process “INVOICE COLLECTION”. For example, the number of current process instances per year is four hundred as computed or extrapolated from the entries 172 and 174 (e.g., 400=100 instances per quarter×four quarters per year). In addition, the cost per process instance is $750.00, as computed from the entry 172 and a factor that is applied to the given interval to extrapolate the value to an annual attainment (e.g., once per week can be extrapolated to fifty-two times per year). Thus, $750.00 is equal to the average cost per process instance given the current mode of operations (baseline values). The peak number of process instances per year is 41,600, as computed from the entry 178 and a factor that is applied to the given instance interval to extrapolate the value to an annual attainment (e.g., once per week can be extrapolated to fifty-two times per year). Thus, 41,600 is equal to the theoretical peak process instances achievable per year given the time and people constraints established as the baseline. The cost per process instance [maximum] is computed from the entries 185 and 180, is $7.21 (e.g., $7.21=$300,000/41,600), and represents the theoretical cost per process instance for the entered data for the process “INVOICE COLLECTION”. The potential process instance improvement per year is 41,200, as computed by the entries 182 and 176 (e.g., 41,600−400). As illustrated in the table 170 in FIG. 12, the “Total Annual Process Cost for the Department Role” for the role “FINANCE” is $300,000, as computed by the entries 171 and 152 from the Department Roles (see FIG. 4) and is a reflection of the full-time cost of an employee performing the process “INVOICE COLLECTION” from the role “FINANCE” (e.g., $300,000=4×$75,000). While the table or interface 170 illustrates information provided for the process “INVOICE COLLECTION” for the role “FINANCE” for the strategy “IMPROVE DAYS SALES OUTSTANDING”, other processes also may be entered for this role and strategy in a similar manner.

As illustrated in the portion of table 170 in FIG. 12, example conservative, probable, and assertive actual target estimates have been entered for various attributes or baseline values of the process “INVOICE COLLECTION”. In some embodiments, a user may be prompted, queried, or required to provide the target estimate information.

The actual target estimates reflect or are a measure of potential improvements for the process “INVOICE COLLECTION” based on specific or actual targeted improvements resulting from implementation of the process “INVOICE COLLECTION”. In some embodiments, conservative actual estimates, probable actual estimates, and assertive or aggressive actual estimates may be entered for the initial baseline values.

If desired, percentage target estimates may be used instead of the actual target estimates and in some embodiments actual target estimates and percentage target estimates may be used simultaneously. For example one might specify a new target value for the “NUMBER OF PEOPLE WITHIN THE ROLE WHOLE PERFORM THIS PROCESS” as a new conservative actual target of “9.00” from the entered baseline value of “10.00” or it could have been expressed as a conservative percentage target of “90%” of the baseline entry. In either case the baseline entry value can be forecasted conservatively to be reduced by a value of one (i.e., reducing the number of employees in role who perform the process by one) as a result of the implementation of the process “INVOICE COLLECTION”. A probable actual estimate of “7.00” and an assertive actual estimate of “5.00” are illustrated in the table 170 of FIG. 12, which are equivalent to a probable percentage estimate of “70%” and an assertive percentage estimate of “50%” for the initial baseline value of “10”.

In some embodiments, filing or entering in a value for an actual target estimate in the table 170 for a baseline value may result in the appropriate number being filled or entered in for the related percentage target estimate. For example, entering the value “9.00” for the conservative actual estimate for the attribute “NUMBER OF PEOPLE WITHIN THE ROLE WHOLE PERFORM THIS PROCESS” may result in the value of “90%” automatically being filled in the table 170 for the conservative percentage actual target estimate for the attribute, and vice versa.

Now referring to FIG. 13, the conservative, probable, and assertive target estimates entered via or in the table 170 may be used to generate actual conservative, probable, and assertive delta contributions as well as percentage conservative, probable, and assertive delta contributions, all of which reflect or are a measure of the future or forecasted state of a given benchmark attribute for a process if the process is implemented. For example, a user might forecast for the attribute “NUMBER OF PEOPLE NEEDED TO PERFORM ONE INSTANCE OF PROCESS” conservatively, probably and assertively to be 4, 3, and 1 respectively, thereby providing a range of future states which aides in risk and sensitivity analysis of the conservative, probable, and assertive contributions of this attribute for the process “INVOICE COLLECTION to be analyzed.

In addition, the conservative, probable, and assertive target estimates may be used to generate or determine conservative, probable, and assertive target contributions for the process, which reflect or are a measure of the improvements or changes versus the entered baseline values for the process. For example, if one entered “10” for “NUMBER OF PEOPLE WITHIN THE ROLE WHO PERFORM THIS PROCESS” and a probable target percentage estimate value of “70%”, the resultant target contribution would be “7”. This factor would be applied to formulating a new “TOTAL ANNUAL PROCESS COST FOR DEPARTMENT ROLE” based on probable entries 194.

As illustrated by entries 186, 188, 190, new target contributions are established using the same formulaic process as in the case of the baseline function. For example, the respective (conservative, probably and assertive) values for the attribute “FULL TIME EQUIVALENTS FOR PERFORMING THE PROCESS” is multiplied by the attribute “FULLY LOADED COST OF HEADCOUNT FROM DEPARTMENT” for the respective targets. The conservative value of $121,500.00 is equal to $75,000.00 (see entry 153)×1.62, the probable value of 78,750.00 is equal to $75,000.00×1.05, and the assertive value of $48,750.00 is equal to $75,000×0.65.

In some embodiments, these target contributions may be conservative (relatively little change from the established baseline); probable (a more likely improvement over the baseline and conservative estimate); and assertive (a significant improvement over the baseline and probable estimate). Also, as illustrated by entries 192, 194, 196, target contributions or “net results” are displayed based on whether the benchmark is targeting a cost savings (“C”) or a revenue increase (“R”). For a cost savings, the baseline value (e.g., $300,000.00) is subtracted from each of the target states (conservative, probable and assertive). Conversely, for a revenue increase, each of the target states (conservative, probable and assertive) is subtracted from the baseline value “$300,000.00”. In both cases the result is reported as the ultimate annual target contribution for the process. For example, improving the process INVOICE COLLECTION as it relates to the strategy IMPROVE DAYS SALES OUTSTANDING causes projections of conservative, probable and assertive improved operational efficiency in the amounts of $178,500 (see entry 192) (e.g., $178,500.00=300,000.00−(1.62×$75,000)), $221,250 (see entry 194), and $251,250 (see entry 196) respectively. Each of which were derived by subtracting the established baseline from the respective conservative, probable and assertive target contribution or: $300,000.00−$121,500.00 (see entry 186); $300,000.00 (185) $78,750.00 (see entry 188) and $300,000.00−$48,750 (see entry 190). The attributes and formulas used in the table 170 are associated with the benchmarking mode selected during the step 102. A different benchmarking mode may use different attributes and/or formulas for analyzing the process “INVOICE COLLECTION”.

As illustrated in table 170 in FIG. 13, in some embodiments the table 170 may inform a user of a systems generated message or allow a user to enter information or assumptions made or used when entering some of the information in the table 170. For example, a message may notify a user that a number such as “NUMBER OF PEOPLE NEEDED TO PERFORM ONE INSTANCE OF PROCESS” is negative and therefore unacceptable for further processing. Likewise, a user may enter an assumption for the field “NUMBER OF PEOPLE WITHIN THE ROLE WHO PERFORM THIS PROCESS” which provides justification for altering the baseline values with new projected conservative, probable and actual targets. One such assumption might be “Improved email communication will lessen our need for people, thus we are reducing the number of people within this role, involved with this process”.

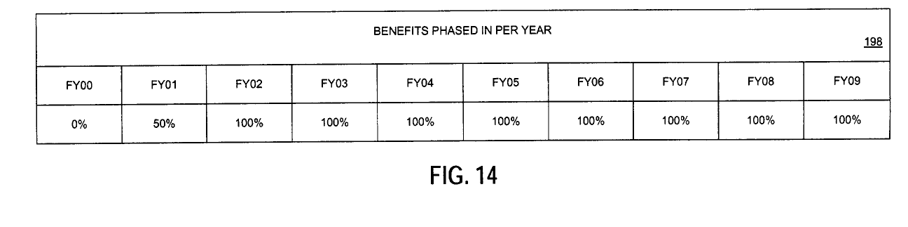

The interface used in the step 126 also may allow a user to provide or enter information regarding phasing in of the benefits of derived from the delta of the baseline and target contributions determined from the table 170, as illustrated in table 198 in FIG. 14. For the example table 198 for the process “INVOICE COLLECTION” and the role “FINANCE” described in the interface 170, zero percent of the benefit of the example benchmark “INVOICE COLLECTION” will be obtained during the first year of execution of the process “INVOICE COLLECTION”, fifty percent of the benefit of this same benchmark will be realized in the second year of execution of the process “INVOICE COLLECTION” roll-out and one hundred percent of the benefit of the process “INVOICE COLLECTION” will be obtained during each of the remaining years for which the process is managed, etc. The benefit information provided in table 198 is a reflection or measure of the one-time, or in this case, recurring benefits which the organization will realize for the forecasted improvement to the process “INVOICE COLLECTION”. In some embodiments, a user may be prompted or queried to provide the information in the table 198, which will be used as a multiplier to extrapolate conservative, probable and assertive target values for the duration that the organization is being modeled and the impact is being measured.

Referring once again to FIG. 8, during a step 128 at least one asset is determined for at least one of the processes determined during the step 126. Thus, the at least one asset becomes associated with the strategy. In some embodiments, one or more assets may be determined for some or all of the processes determined during the step 126. There is no limit to the number of assets that may be encompassed by or related to a single process and/or to a strategy. An asset may be or include a physical asset, a digital asset, and/or a collaborative asset and may be related to more than one process, role and/or strategy.

As previously discussed above, a physical asset can be or include, but is not limited to, buildings, plants and equipment. A digital asset can be or include, but is not limited to, software, hardware, IT subscription services, and syndicated data. A collaborative asset can be or include, but is not limited to, customers, distributors, suppliers, outsourced employees or other partners. In some embodiments, collaborative assets will refer to include people outside of a given organization who impact the throughput characteristics of a process, digital asset or physical asset. Collaborative assets may create, extend, enhance or replace existing business processes or resources such as physical and digital assets. Benchmarks used to analyze or obtain information regarding collaborative assets may aim to measure the impact collaborative assets such as customers, suppliers, distributors, or outsourced personnel may have on an organization by decreasing costs or enabling new forms of revenue.

In some embodiments, identification of an asset during the step 128 may include gathering additional information regarding the asset or allowing a user to enter information regarding the asset. For example, in some embodiments, identification of a digital asset may include obtaining attribute information regarding the asset such as, for example: (1) information regarding a description of the digital asset; (2) identification of a vendor associated with the digital asset; (3) information regarding the digital asset's product name, version, release, source, licensing model; and (4) information regarding the digital asset's relevance to the process determined during the step 126. In some embodiments, a device or software may query or prompt a user to provide this information.

In addition to the above information, in some embodiments, identification of a digital asset during the step 128 may include obtaining attribute information such as, for example: (1) the number of digital asset units; (2) the year the digital asset units were acquired (for the purpose of managing time-based depreciation); (3) the list price per digital asset unit acquired; (4) the volume purchase discount percentage for the digital asset; (5) the annual percentage maintenance charge of the list price of the digital asset; (6) the number of years to depreciate for the digital asset; and (7) the quantity of units of the digital asset in production for the associated process. For example a computer that was purchased may be depreciated over a three year period and since it was purchased in a quantity of ten or more, a volume discount may be recorded for the asset, but perhaps not the annual recurring maintenance fees. The digital asset benchmark models the volume discounting, on-going maintenance, depreciation and utilization (both from a production versus development/test mode of operation and from a business role such as “SALES”). In some embodiments, a device or software may query or prompt a user to provide this information.

In addition to the information provided above, in some embodiments the step 128 may include obtain target information regarding a digital asset. For example, the step 128 may include obtaining conservative, probable and/or assertive actual estimates or percentage estimates for different aspects of the digital asset for use in evaluating the digital asset in relation to the asset's related process. In some embodiments, a device or software may query or prompt a user to provide this target information.

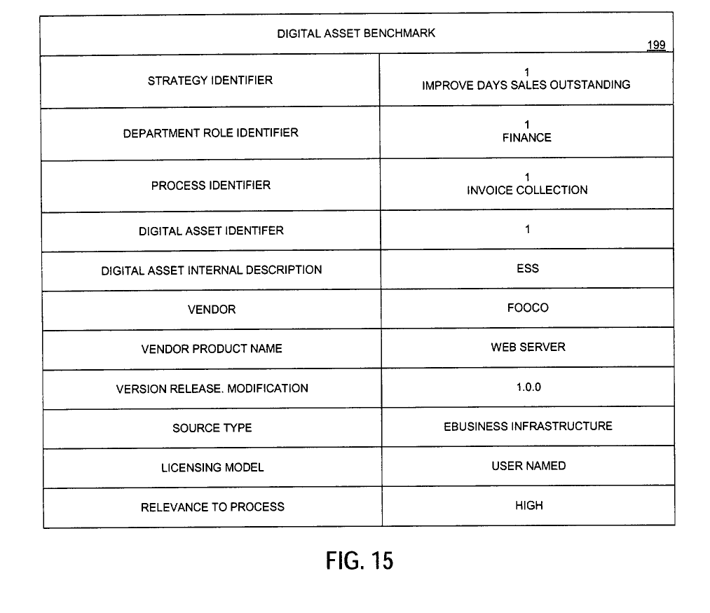

In some embodiments, the step 128 may be implemented via an interface that allows a user to identify or enter one or more assets and associate them with one or more processes determined during the step 126. In some embodiments, the interface may be implemented via browser or other software operating on a user device or on a Web site. For example, an interface or table 199 as illustrated in FIG. 15 may allow a user to enter one or more digital assets relative to the process “INVOICE COLLECTION” for the role “FINANCE” and the strategy “IMPROVE DAYS SALES OUTSTANDING”.

As illustrated in the table 199, a digital asset identified as “ESS” for “Employee Self-Service” and is associated with the process of “INVOICE COLLECTION”, which is, in turn, associated with the role of “FINANCE” and the strategy “IMPROVE DAYS SALES OUTSTANDING”. The digital asset “ESS” is associated with the vendor “FOOCO” and the vendor product name is “WEB SERVER”. The digital asset “ESS” has a “HIGH” relevance to or use in the process “INVOICE COLLECTION” and is designated as having a “USER NAMED” licensing model and an “EBUSINESS INFRASTRUCTURE” source type, which are indications that the digital asset cost scales proportional with the number of users of the asset and that the asset underlies many other assets and is therefore deemed “EBUSINESS INFRASTRUCTURE”, based on user naming preference or user selection.

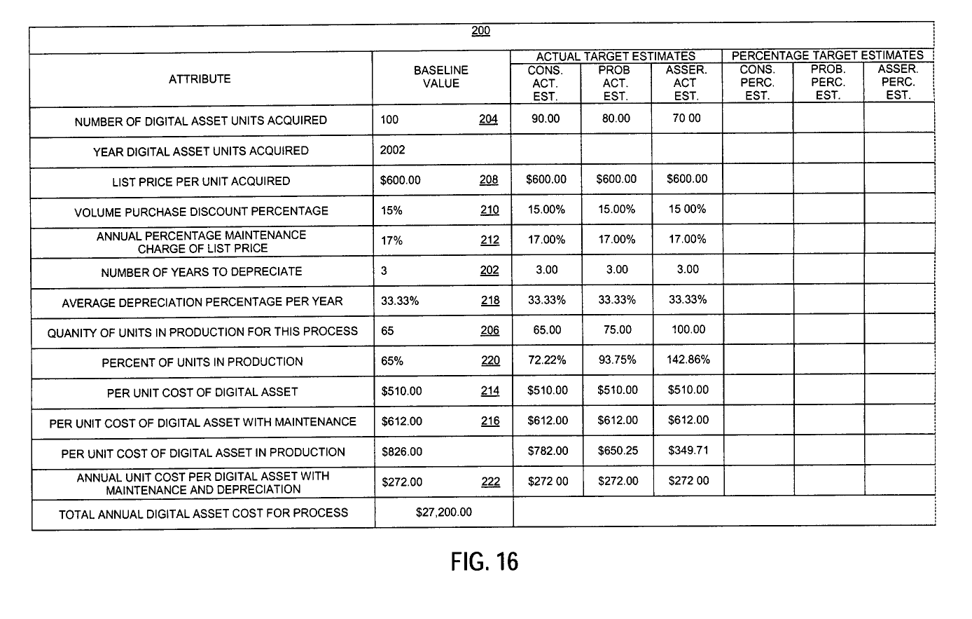

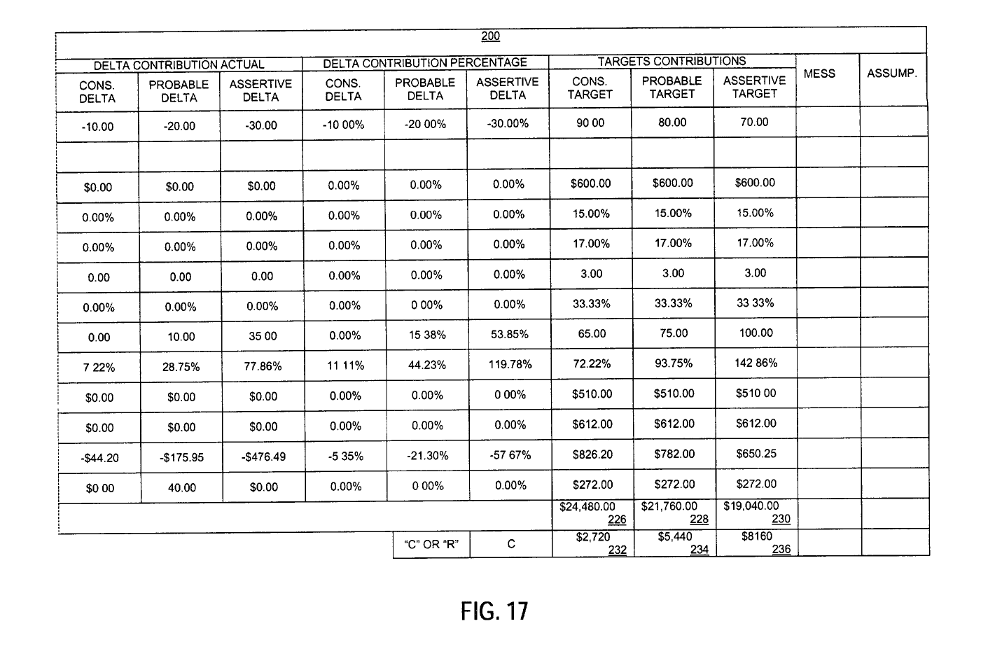

The interface used in the step 128 to allow a user to enter attribute information describing a digital asset “ESS” also may allow the user to enter or provide information regarding the digital asset “ESS”. For example, now referring to a representative table or interface 200 in FIGS. 16 and 17, there are one hundred units of the digital asset “ESS”, all of which were acquired in the year 2002. Information of similar digital assets acquired in different years may be entered or provided as a separate digital asset. The list price per unit of the digital asset “ESS” is $600.00 and a volume purchase discount of fifteen percent applies, which means that the actual purchase price per unit for the digital asset is fifteen percent less the entered list price per unit licensed of the digital asset “ESS” since the quantity of units acquired (100) was sufficient to justify a discount from the vendor. The annual percentage maintenance charge of the list price per unit of the digital asset “ESS” is seventeen percent, which means that each year, for the life of the digital asset “ESS”, a recurring annual fee of seventeen percent will be charged the firm for on-going software maintenance, help-desk support on related software modifications needed by the purchaser. The number of years to depreciate each unit of the digital asset “ESS” is three. The quantity of units in production for the process “INVOICE COLLECTION” is sixty-five.

Also as illustrated in the table 200, several variables can be computed regarding the digital asset “ESS”. For example, the average depreciation percentage per year of the digital asset “ESS” can be computed from the entry 202 and is 33.33% (i.e., 1/3×100%). The percentage of units of the digital asset “ESS” can be computed from the entries 204 and 206 and is sixty-five percent (e.g., 65%=65/100×100%). The per unit cost of the digital asset “ESS” is $510.00 and can be computed from the entries 208 and 210 (e.g., $510.00=$600.00×(1−0.15)). The per unit cost of the digital asset “ESS” with maintenance is $612.00 and is computed from the entries 208, 212 and 214 (e.g., $612.00=$510.00+($600.00×0.17)). The per unit cost of the digital asset “ESS” in production is $826.20 and is computed from the entries 216 and 220 (e.g., $826.20=$612.00×(1+(1−0.65))). The annual per unit cost of the digital asset “ESS” with maintenance and depreciation is $272.00 and is computed by the entries 208, 212, 214, and 218 (e.g., $272.00=($510.00×0.33)+($600.00×0.17)). The total annual “ESS” digital asset cost for the process “INVOICE COLLECTION” is $27,200.00 (see entry 224), is computed by the entries 204 and 222 (e.g., $27,000.00=100×$272.00), and reflects the cost of ownership, including depreciation and ongoing maintenance of the digital asset “ESS” in production over the life of the asset “ESS”. The attributes and formulas used in the table 200 are associated with the benchmarking mode selected during the step 102. A different benchmarking mode may use different attributes or formulas for analyzing the digital asset “ESS”.

As illustrated in the interface or table 200 in FIG. 16, conservative, probable, and assertive actual target estimates have been entered for various attributes of the digital asset “ESS”. The actual target estimates reflect or are a measure of precise or actual changes to baseline values for the digital asset “ESS”, as previously discussed above with regard to the process “INVOICE COLLECTION”. If desired, percentage target estimates could have been used instead of the actual target estimates also as previously discussed above. In some embodiments a user may be prompted, queried, or required to provide the target estimate information in the table 200.

Now referring to FIG. 17, the conservative, probable, and assertive target estimates entered via in the table 200 may be used to generate actual conservative, probable, and assertive delta contributions as well as percentage conservative, probable, and assertive delta contributions, all of which reflect or are a measure of the delta or difference between the baseline or current state of operation and the forecasted or proposed state of operation of the digital asset “ESS”. In addition, the conservative, probable, and assertive target estimates may be used to generate conservative, probable, and assertive target contributions, which reflect or are a measure of the increase or decrease over the baseline value which was determined for each of the forecasted target states (conservative, probable and assertive), as previously discussed above.

As illustrated by entries 226, 228, 230, new target contributions are established using the same formulaic process as in the case of the baseline function and attribute values, as previously discussed above. For example, the baseline value of $27,200.00 (see entry 224) is determined by multiplying the field “ANNUAL UNIT COST PER DIGITAL ASSET WITH MAINTENANCE AND DEPRECIATION” (see entry 222) times “NUMBER OF DIGITAL ASSET UNITS ACQUIRED” (see entry 204). Likewise conservative, probable and assertive values may be determined by multiplying the values in the respective fields or column entries accordingly.

Also, as illustrated by the entries 232, 234, 236, target contributions or “net results” are displayed based on whether the benchmark is targeting a cost savings or revenue increase. For a cost savings (“C”), the baseline value $27,200.00 is subtracted from each of the target states (conservative, probable and assertive). Conversely, for a revenue increase (“R”), each of the target states (conservative, probable and assertive) is subtracted from the baseline value $27,200.00. In both cases the result is reported as the ultimate annual target contribution. In the course of performing the process outlined in table 170; one or more instances of the digital asset outlined in table 200 may be consumed. A user may impose one or more such relationships depending on the demand for digital assets while executing a business process.

As illustrated in table 200 in FIG. 17, in some embodiments the table 200 a message may inform a user of possible errors or may permit users to enter assumptions made used when entering some of the information in the table 200. For example, the message “YEAR ENTERED RENDERS DIGITAL ASSET FULLY DEPERECIATED” might appear if a user enters values for “YEAR DIGITAL ASSET ACQUIRED” and “NUMBER OF YEARS TO DEPRECIATE” which are inconsistent with the current date. Additionally, a user may enter an assumption for the field “NUMBER OF DIGITAL ASSET UNITS ACQUIRED” to the effect of “ONE ASSET LICENSED PER EMPLOYEE IN DEPARTMENT”, to substantiate the nature of their input.

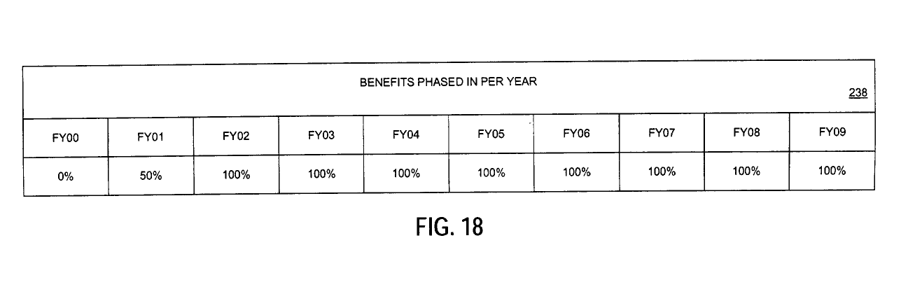

The interface used in the step 128 also may allow a user to provide or enter information regarding phasing in of the benefits of the digital asset “ESS”, as illustrated in table 238 in FIG. 18. In some embodiments, the user may be queried, prompted or required to provide the information. For the example table 238 for the digital asset “ESS” described in the tables 199 and 200, zero percent of the benefit of the digital asset “ESS” will be obtained during the first year of the project life-cycle of the proposed strategy “IMPROVE DAYS SALES OUTSTANDING”, fifty percent of the benefit of the digital asset “ESS” will be obtained during the second (01) or “Fiscal Year” (FY), one hundred percent of the benefit of the digital asset “ESS” will be obtained during each following year as a recurring annual benefit, etc. The benefit information provided in table 238 is a reflection or measure of the annual recurrence and extent for which the digital asset “ESS” makes a contribution to a process “INVOICE COLLECTION” and the strategy “IMPROVE DAYS SALES OUTSTANDING” over the lifecycle (years) it is modeled. In some embodiments, a user may be prompted or queried to provide the information in the table 238.

While the table 200 illustrates information provided for the digital asset “ESS” for the process “INVOICE COLLECTION”, the role “FINANCE”, and the strategy “IMPROVE DAYS SALES OUTSTANDING”, other digital assets also may be entered for this process, role and strategy in a similar manner.

In some embodiments, identification of an asset during the step 128 may include gathering additional information regarding attributes of a physical asset. For example, in some embodiments, identification of a physical asset may include obtaining information such as information regarding a description of the physical asset and/or information regarding the year in which the physical asset was acquired.

In addition to the above information, in some embodiments, identification of a physical asset during the step 128 may include obtaining attribute information regarding the physical asset such as, for example: (1) the number of units of the physical asset and the year the units of the physical asset were acquired; (2) the percentage of the physical asset dedicated to the process associated with the physical asset (e.g., in this case “INVOICE COLLECTION”); (3) the average net cost per physical asset; (4) the average physical asset indirect cost loading factor (e.g., facilities cost, insurance cost, maintenance cost), which is an indication of the cost of ownership to service and maintain the asset; (5) the total number of years to depreciate the physical asset; (6) the average depreciation percentage per year for the physical asset; (7) the theoretical peak cycles for unit of measure per time interval, which is an indication of the maximum number of times per year the physical asset can be stocked, assuming all other baseline values (some industries such as retail refer to this as “Inventory Turns”); (8) the average realized cycles for process per interval, which is an indication of actual stocking and replenishment characteristics achieved by the organization; (9) the theoretical peak cycles for unit of measure per year, which is an indication of peak stock and replenishment levels normalized to a period of one year (versus weekly, quarterly, etc.); (10) the average realized cycles for process per year, which is an indication of the average realized stocking and replenishment of the physical asset per year (versus per week, quarter, etc.); and (11) the description of units cycled via the physical asset and its associated cycle unit of measure and cycle unit time interval, all of which are an indication of the throughput by which the physical asset is stocked and replenished for a given interval and/or year.

Physical assets, particularly property, plant and equipment assets are best measured based on throughput characteristics. When time constraints are included with throughput measures, productivity can be measured and forecasted. The physical asset benchmark sets to establish the theoretical peak performance of a given physical asset, actual utilization and forecast realistic improvements. For example, a key measure of throughput through a physical asset such as a warehouse is inventory turns. If a building can physically turn inventory (i.e., the inventory in the warehouse can be totally stocked and replenished) within twenty-four hours, the theoretical inventory turns for that warehouse would be 365 per year. This physical asset benchmark seeks to establish the upper limit of 365; baseline actual (real world) performance and project the impact of future improvements. Questions such as “If we could improve the inventory turns through or major warehouse by ten percent, would we be able to close our satellite warehouses?” can be answered by the computations embodied by this physical asset benchmark.

In addition to the information provided above, in some embodiments the step 128 may include obtain target information regarding a physical asset. For example, the step 128 may include obtaining conservative, probable and/or assertive actual estimates or percentage estimates for different aspects of the physical asset for use in evaluating the physical asset as previously described above. In some embodiments, a user may be prompted, queried or required to provide the target estimate information.

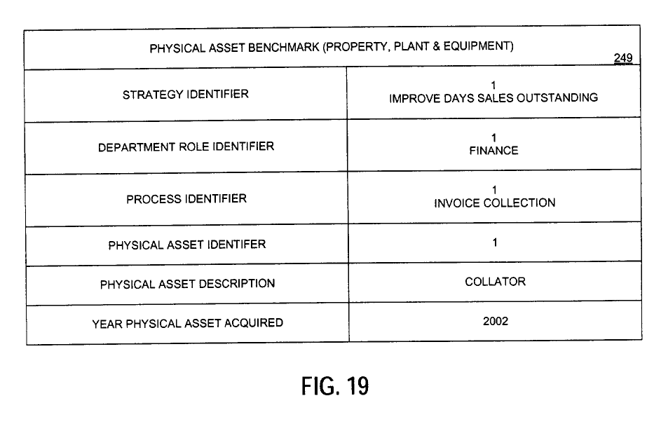

In some embodiments, the step 128 may be implemented via an interface that allows a user to identify or enter one or more physical assets and associate them with one or more processes determined during the step 126. For example, an interface or table 249 as illustrated in FIG. 19 may allow a user to enter information regarding one or more physical assets relative to the process “INVOICE COLLECTION” for the role “FINANCE” and the strategy “IMPROVE DAYS SALES OUTSTANDING”. The table 249 is particularly well suited for physical assets involving or including property, plant or equipment. Such a physical asset may be or include, for example, a warehouse, acreage of farming land, a computer, an assembly line or foundry, etc.

As illustrated in the table 249, a physical asset identified as “COLLATOR” is associated with the process of “INVOICE COLLECTION”, which is, in turn, associated with the role of “FINANCE” and the strategy “IMPROVE DAYS SALES OUTSTANDING”. The physical asset “COLLATOR” was acquired in the year 2002.

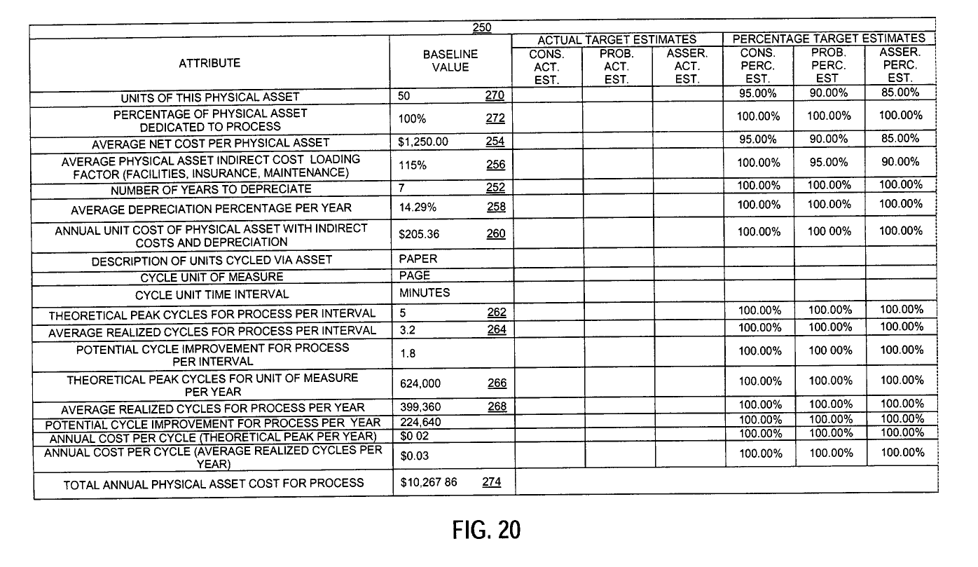

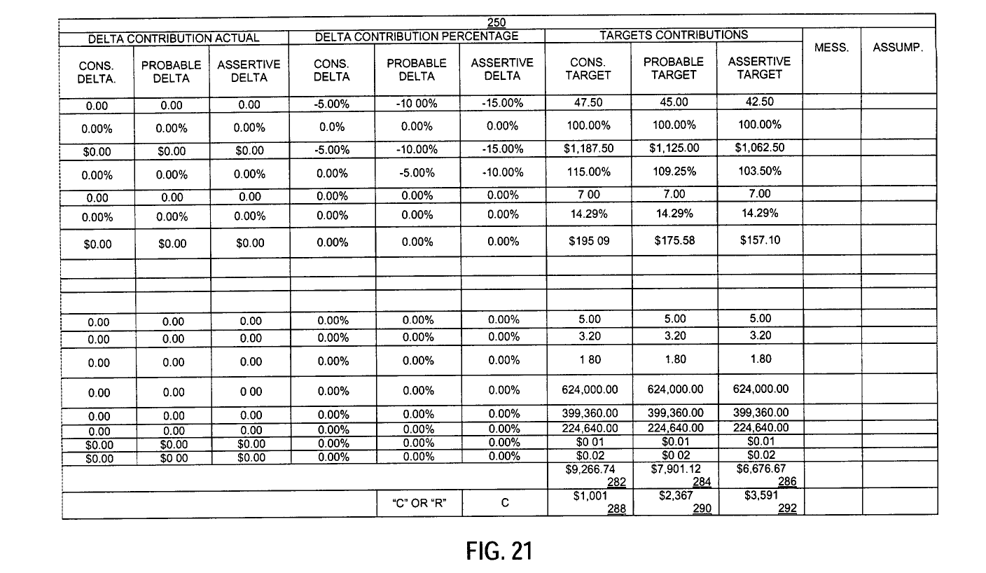

The interface involved in or used for the step 128 also may include a table 250 illustrated in FIGS. 20 and 21 that allow a user to enter or provide additional information regarding the physical asset “COLLATOR”. For example, as illustrated in the table 250 in FIG. 20, there are fifty units of the physical asset “COLLATOR”, with one hundred percent of each of the fifty units being dedicated to the process “INVOICE COLLECTION” and the average net cost per unit of the physical asset “COLLATOR” being $1,250.00. The average physical asset indirect cost loading factor is 115 percent and the number of years to depreciate the asset is seven. The theoretical peak cycles for unit of measure of time per time interval is five and the average realized cycles for the process “INVOICE COLLECTION” per interval is 3.2. This information provides the variables needed to understand how collators in an organization are consumed during the process of “INVOICE COLLECTION”. By having a detailed understanding, which is aligned with the process “INVOICE COLLECTION”, methods can be explored of improving the collating step of the process “INVOICE COLLECTION” that drive the physical asset “COLLATOR” from its baseline state of 3.2 cycles per interval closer to its theoretical peak of five cycles per interval. The theoretical peak cycles per unit of measure per year is 624,000 and the average realized cycles for the process “INVOICE COLLECTION” is 399,369. Thus, from extrapolation, it can be determined that if the physical asset “COLLATOR” was left to collate for maximum business hours for a maximum of business days a year it would yield the theoretical output figure of 624,000. However the baseline data in table 250 reveals that the throughput characteristics of the physical asset “COLLATOR” is significantly less, thereby representing an opportunity for improvement in the overall process of “INVOICE COLLECTION”. The description of units cycled via the physical asset “COLLATOR” is “PAPER”, the cycle unit of measure is “PAGE” and the cycle unit time interval is “MINUTES”. In some embodiments, a user may be queried or prompted to provide the attribute information for the table 250.

Also as illustrated in the table 250 in FIG. 20, several attributes can be computed regarding the physical asset “COLLATOR”. For example, the average depreciation percentage per year for the physical asset “COLLATOR” is 14.29 percent and is computed from the entry 252 (e.g., 1/7×100%). The annual unit cost of the physical asset “COLLATOR” is $205.26 (e.g., entry 260) and is computed from the entries 254, 256 and 258 (e.g., $205.26=$1,250.00×1.15×0.1429). The potential cycle improvement for the process “INVOICE COLLECTION” per interval is 1.8 and is computed from the entries 262 and 264 (e.g., 5−1.8). The potential cycle improvement for the process “INVOICE COLLECTION” is 224,640 and is computed from the entries 266 and 218 (e.g., 624,000−399,360). The total annual physical asset cost for the process “INVOICE COLLECTION” is $10,267.86, is computed from the entries 260, 270, and 272 (e.g., $10,267.86=50×1×$205.36), and represents fully loaded cost (including depreciation and indirect costs such as electricity) for the collators to process invoice collections. From this, the annual cost per cycle can be computed from the entries 266 and 274 as $0.02 (e.g., $0.02=$10,267.86/624,000). In addition, the annual cost per cycle can be computed from the entries 268 and 274 as $0.03 (e.g., $0.03=$10,267.86/399,360).

The attributes and formulas used in the table 250 are associated with the benchmarking mode selected during the step 102. A different benchmarking mode may use different attributes or formulas for analysis of the physical asset “COLLATOR”.

As illustrated in the table 250 in FIG. 20, conservative, probable, and assertive actual target estimates have been entered for various attributes of the physical asset “COLLATOR”. The actual target estimates reflect or are a measure of the future or forecasted state of the given physical asset benchmark attribute. If desired, percentage target estimates could have been used instead of the actual target estimates, as previously discussed above. Now referring to FIG. 21, the conservative, probable, and assertive target estimates in the table 250 illustrated in FIG. 20 may be used to generate actual conservative, probable, and assertive delta contributions as well as percentage conservative, probable, and assertive delta contributions, all of which reflect or are a measure of the improvements or changes resulting from contribution of the physical asset “COLLATOR” versus the entered baseline values, as previously discussed above. In addition, the conservative, probable, and assertive target estimates are used to generate or determine conservative, probable, and assertive target contributions, which reflect or are a measure of the ultimate target values or differences from the established baseline values for the physical asset. In some embodiments, a user may be prompted, queried or required to provide the target estimate information in the table 250.

As illustrated by entries 282, 284, 286, new target contributions are established using the same formulaic process as in the case of the baseline function or value, as previously discussed above. For example, the baseline value $10,267.86 (see entry 274) is computed by multiplying UNITS OF THIS PHYSICAL ASSET (see entry 270) times PERCENTAGE OF PHYSICAL ASSET DEDICATED TO PROCESS (see entry 272) times ANNUAL UNIT COST OF PHYSICAL ASSET WITH INDIRECT COSTS AND DEPRECIATION (see entry 260). Using this same logic and formula, the conservative, probable and assertive targets may be computed with the inclusion of their representative values. Also, as illustrated by the entries 288, 290, 292, target contributions or “net results” are displayed based on whether the benchmark is targeting a cost savings or revenue increase. For a cost savings (“C”), the baseline value $10,267.86 is subtracted from each of the target states (conservative, probable and assertive). Conversely, for a revenue increase (“R”), each of the target states (conservative, probable and assertive) is subtracted from the baseline value $10,267.86. In both cases the result is reported as the ultimate annual target contribution. The baseline value TOTAL ANNUAL PHYSICAL ASSET COST FOR PROCESS (entry 274) of $10,267.86 represents process costing for the current organization operations. To quantify a cost savings derived by the new target states the conservative (see entry 282), probable (see entry 284) and assertive (see entry 286) target states are subtracted from the baseline value of $10,267.86 yielding the operational improvement quantified and labeled conservative (see entry 288), probable (see entry 290) and assertive (sentry 292) target contributions. This physical asset is consumed by or used in the process “INVOICE COLLECTION” previously described above.

As illustrated in table 250 in FIG. 21, in some embodiments the table 250 may present the user with messages or allow the user to enter assumptions made or used when entering some of the information in the table 250. For example, if the value “0” was entered for “UNITS OF THIS PHYSICAL ASSET” (entry 270)”, a message might appear warning the user that at least one physical asset must be present to formulate a response. Additionally, a user who decreases the “PERCENTAGE OF PHYSICAL ASSET DEDICATED TO THIS PROCESS” (entry 272) might include the assumption: “BY REDUCING THE NUMBER OF PEOPLE WITHIN THIS ROLE WHO PERFORM INVOICE COLLECTION THE PERCENTAGE OF THIS PHYSICAL ASSET CAN BE REDUCED”. Messages provide feedback to users on the context and relevance of their information, while assumptions provide the user the means to alter or add context and relevance to their information.

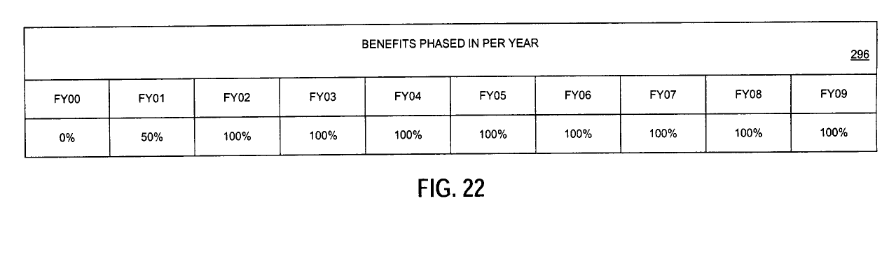

The interface used during the step 128 also may allow a user to provide or enter information regarding phasing in of the benefits of the physical asset “COLLATOR”, as illustrated in table 296 in FIG. 22. For the example table 296 for the physical asset “COLLATOR” described in the tables 249 and 250, zero percent of the benefit of the physical asset “COLLATOR” will be obtained during this first year of the implementation of the strategy “IMPROVE DAYS SALES OUTSTANDING, fifty percent of the benefit provided by the physical asset “COLLATOR” will be realized during the second fiscal year (FY01), one hundred percent of the benefit of the physical asset “COLLATOR” will be obtained during each of the all successive years where the performance of the physical asset “COLLATOR” is monitored (FY02-FY09). The benefit information provided in the table 296 is a reflection or measure of the annual recurrence and extent for which the physical asset “COLLATOR” makes a contribution to the process “INVOICE COLLECTION” and the strategy “IMPROVE DAYS SALES OUTSTANDING” over the lifecycle (years) it is modeled. In some embodiments, a user may be prompted or queried to provide the information in the table 238. The table 296 permits phasing in and out of benefits (contributions) commensurate with business objectives and requirements across a period of one or more years. Such benefits may be aggregated across all years; roles; at the strategy level, or across all multiple strategies.

While the tables 249 and 250 illustrate information provided for the physical asset “COLLATOR” for the process “INVOICE COLLECTION”, the role “FINANCE”, and the strategy “IMPROVE DAYS SALES OUTSTANDING”, other physical assets also may be entered for this process, role and strategy in a similar manner.

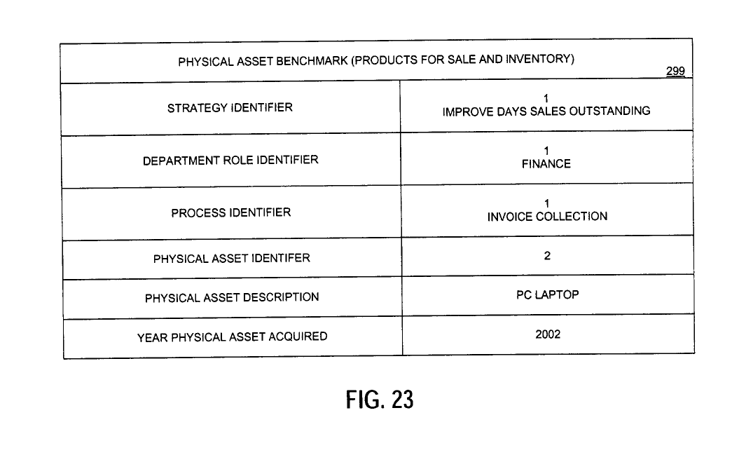

In some embodiments, different types of physical assets may use different formulas/variables as part of the benchmarking process or as part of different benchmarking modes. For example, while the tables 249 and 250 are particularly well suited for physical assets involving or including property, plant or equipment, a different table or interface and different benchmarking attributes and formulas may be used for physical assets involving or including products, an example of which is illustrated in FIGS. 23-26. Different physical asset benchmarks provide general purpose models for different physical assets which may force an organization to incur costs versus generating revenue. The physical asset benchmark for property, plant and equipment deals primarily with incurring cost and how a model can be formulated to avoid or reduce costs; where the physical asset benchmark products for sale and inventory deals with creating revenue through the sale of parts and/or finished goods.

As illustrated in a table 299 in FIG. 23, a physical asset identified as “PC LAPTOP” is associated with the process of “INVOICE COLLECTION”, which is, in turn, associated with the role of “FINANCE” and the strategy “IMPROVE DAYS SALES OUTSTANDING”. The physical asset “PC LAPTOP” was acquired in the year 2002.

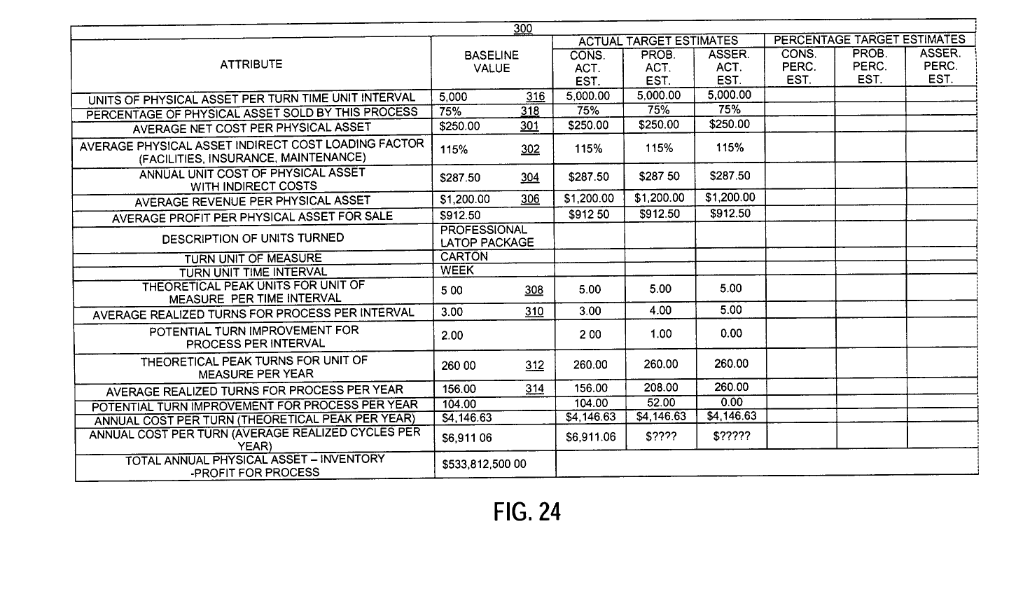

Now referring to FIG. 24, the interface used during the step 128 may include a table 300 that allows entry of attribute information regarding a physical asset for the type “products for sales and inventory”. A user may be prompted or queried to enter, select or provide the attribute information in the table 300.

As illustrated in the table 300, there are five thousand units of the physical asset “PC LAPTOP”, with seventy-five percent of the five thousand units of the physical asset “PC LAPTOP” being dedicated to the process “INVOICE COLLECTION” and the average net cost per unit of the physical asset “PC LAPTOP” being $250.00. The average physical asset indirect cost loading factor is 115 percent and the average revenue per asset is $1,200.00. For the physical asset “PC LAPTOP”, the description of the units turned is “PROFESSIONAL LAPTOP PACKAGE”, the turn unit of measure is “CARTON” and the turn unit time interval is “WEEK”. The theoretical peak unit of the physical asset for unit of measure per time interval is five and the average realized turns for the associated process per interval is three, which are an indication of stocking and replenishment throughput of the physical asset “PC LAPTOP” on a weekly basis. The theoretical turn improvement for the association process per time interval is 260.00, which is an indication of the maximum weekly throughput stocking and replenishment characteristics assuming the baseline parameters given. The average realized turns for the associated process per year is 156.00, which is an indication of annual realized stocking and replenishment normalized per year, rather than another interval period (e.g., week, month, or quarter).

By linking the process “INCOICE COLLECTION” to the physical asset “PC LAPTOP” for revenue at a seventy percent rate, it is stated or assumed that seventy percent of invoices associated with “PROFESSIONAL LAPOP PACKAGE” go uncollected, which impacts the strategy of “IMPROVE DAYS SALES OUSTANDING”. The benchmark for the physical asset “PC LAPTOP” may be used to understand both the scope (units and cost) and throughput characteristics (turns) in an effort to model the problem so that improvements may be introduced that directly improve the situation to a more positive outcome. The interface or table 300 also may allow a user to provide additional information regarding the physical asset “PC LAPTOP” such as, for example, the theoretical peak turns for each unit of the physical asset per interval, the average realized turns for the process “INVOICE COLLECTION” per interval, and the theoretical peak turns for unit of the physical asset per year. By understanding all of the characteristics and implications of inventory turns, more accurate future turn improvements can be projected. For instance, proposing an improvement in inventory turns that exceed the theoretical peak limits would be illogical.

Also as illustrated in the table 300, several attributes can be computed regarding the physical asset “PC LAPTOP”. For example, the average unit cost of the physical asset “PC LAPTOP” can be computed from the entries 301 and 302 and is $287.50 (e.g., $287.50=$250.00×1.15). The average profit per physical asset for sale can be computed from the entries 304, 306, is $912.50 (e.g., $912.50=$1,200.00−$287.50), and is a measure of profit for the physical asset “PC LAPTOP” after all direct and indirect costs are accounted for in the product cost of goods sold. The potential turn improvement for the process “INCOICE COLLECTION” per interval can be computed from the entries 308 and 310 and is 2 (e.g., 5−3), and is a measure of the efficient usage of production resources such as property, plant, equipment and employees for a production run interval (typically less than a year). The potential turn improvement for the process “INVOICE COLLECTION” per year can be computed from the entries 312 and 314, is 104 (e.g., 104=260−156), and is a measure of the efficient usage of production resources such as property, plant, equipment and employees for all production runs within a single year (typically there are multiple runs per year). The annual cost per turn [peak] can be computed from the entries 304, 312, 316, and 318, is $4,146.63 (e.g., $4,146.63=(5,000×0.75×$287.50)/260)), and is a measure of all costs incurred during optimal production conditions and are associated with a given process, in this case “INVOICE COLLECTION”. The annual cost per turn [average] can be computed from the entries 304, 314, 316 and 318, is $6,911.06 (e.g., $6,911.06=(5,000×0.75×$287.50)/156), and is a measure of all costs incurred during average production conditions and are associated with a given process, in this case “INVOICE COLLECTION”. The total annual physical asset inventory (e.g., profit for the process “INCOICE COLLECTION”) can be computed from the entries 316, 318, 320 and 314 is $533,812,500.00 (e.g., $533,812,500.00=5,000×0.75×$912.50×156), and is a measure of the total profit after direct and indirect costs are accounted for the production run which remains uncollected under the process “INVOICE COLLECTION”. This is the extent to which process deficiencies in invoice collections can be substantiated in economic terms and is the profit potential of collecting on the seventy-five percent of invoices which remain outstanding or un-collected therefore impacting days sales outstanding.

As illustrated in the table 300 in FIG. 24, conservative, probable, and assertive actual target estimates have been entered for various attributes of the physical asset “PC LAPTOP”, as previously discussed above. A user may be prompted or queried to provide such target estimate information. If desired, percentage target estimates could have been used instead of the actual target estimates, also as previously discussed above. For example if “average revenue per physical asset” had a baseline value of $1,200.00 and a conservative percentage target of “90%”, then the resultant conservative target contribution would be $1,080.00 (e.g., ninety percent of $1,200.00). If the new target is an actual entry (versus a percentage entry) then the actual amount would simply be carried forward to the appropriate target contribution column.

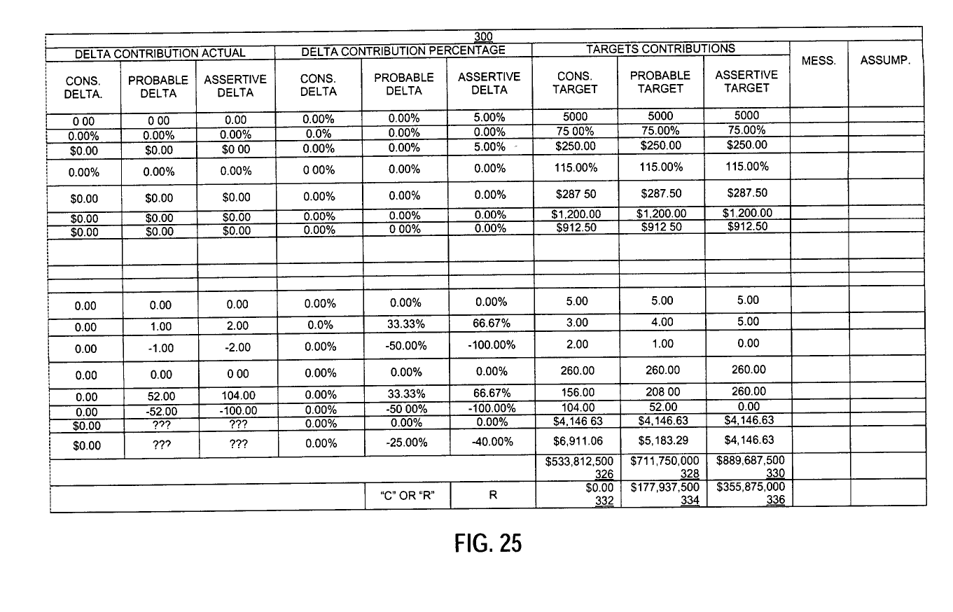

Now referring to FIG. 25, the conservative, probable, and assertive target estimates of the table 300 in FIG. 24 may be used to generate actual conservative, probable, and assertive delta contributions as well as percentage conservative, probable, and assertive delta contributions, all of which reflect or are a measure of the differences between the target value entered and the established baseline value, expressed as an actual number or a percentage delta of the baseline value. For example, “average realized turns for process per interval” has a baseline value of “3.0”; while the conservative, probable and assertive target values are expressed as actual values and are “3.00”, “4.00” and “5.00” respectively. The difference between these values can be expressed as actual amounts or percentages. Actual differences would be 0.00, 1.00 and 2.00 by subtracting the actual target from the baseline value. Percentage differences would be 0.00%, 33.33% and 66.67% when expressing the difference between the target and baseline as a percentage of the baseline values.

The conservative, probable, and assertive target estimates of the table 300 in FIG. 24 are used to generate conservative, probable, and assertive target contributions, which reflect or are a measure of improvements over the baseline using the same formulaic process as in the case of the baseline function, as previously discussed above. For example, “average realized turns for process per interval” has a conservative, probable and assertive target state of “3.00”, “4.00” and “5.00” respectively. These values help establish the conservative target estimate result of “3.00” is equivalent to the baseline value, and once subtracted from the baseline value yields a net difference of zero. However the changes projected by the probable and assertive cases yield values of 1.0 and 0.0 respectively.

As illustrated by the entries 326, 328, 330, new target contributions are established using the same formulaic process as in the case of the baseline function, as previously discussed above. For example, the baseline value of $533,812,500 was determined by multiplying the values for entries 316, 318, 320, and 314 (i.e., 5,000×0.75×$912.50×156). Likewise the conservative, probable and assertive target contribution values 326, 328 and 330 can be calculated using the projected states and identical logic or formulas and the appropriate attribute values. Also, as illustrated by the entries 332, 334, 336, target contributions or “net results” are displayed based on whether the benchmark is targeting a cost savings or revenue increase. For a cost savings, the baseline value “TOTAL ANNUAL PHYSICAL ASSET−INVENTORY PROFIT−PROFIT FOR PROCESS” is subtracted from each of the target states (conservative, probable and assertive). Conversely, for a revenue increase, each of the target states (Conservative, Probable and Assertive) is subtracted from the baseline value “TOTAL ANNUAL PHYSICAL ASSET−INVENTORY PROFIT−PROFIT FOR PROCESS”. In both cases the result is reported as the ultimate annual target contribution. For example, $711,750,000 (see entry 328)−$533,812,500=$177,937,500 (see entry 334) or the probable target contribution for this physical asset model. The table 300 is related to other tables based on the strategy and or role identifier assigned to it and therefore represents the percentage of this physical asset consumed by a particular role in support of a particular strategy.

As illustrated in the table 300 in FIG. 25, in some embodiments the table 300 may allow a user to enter or provide information regarding messages or assumptions made or used when entering some of the information in the table 300, as previously discussed above.

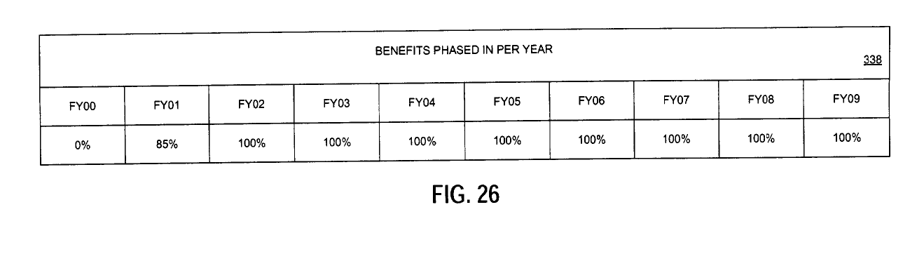

The interface used during the step 128 also may allow a user to provide or enter information regarding phasing in of the benefits of the physical asset “PC LAPTOP” over multiple years, as illustrated in table 338 in FIG. 26. For the example table 338 for the physical asset “PC LAPTOP” described in the tables 299 and 300, zero percent of the benefit of the improvement of utilization (turns) of the physical assets “PC LAPTOP” will be obtained during the first fiscal year which the undertaking is managed to implement the strategy “IMPROVE DAYS SALES OUTSTANDING” and the process “INVOICE COLLECTION”, eighty-five percent of the benefit of the improved physical asset utilization will be obtained during the second fiscal year, one hundred percent of the benefit of the physical asset turns will be obtained during each of the subsequent years as a recurring annual benefit. The benefit information provided in table 338 is a reflection or measure of the annual recurrence and extent for which the improved physical asset turns makes a contribution to the implementation of the strategy “IMPROVE DAYS SALES OUTSTANDING” or the process “INVOICE COLLECTION” over the lifecycle (years) it is modeled. A user may be prompted or queried to provide the information in the table 338. Values that are entered by year may be aggregated to the role level and from the role level to the strategy level. Additionally, all aggregate values may be aggregated across all strategies providing a phasing and analysis of benefits at the benchmark, role and strategy as well as across strategies.

In some embodiments, identification of an asset during the step 128 may include gathering additional attribute information regarding a collaborative asset. For example, in some embodiments, identification of a collaborative asset may include obtaining information such as information regarding a description of the collaborative asset and/or information regarding the year in which the collaborative asset was acquired. A user may be prompted or queried to provide the attribute information. In addition to the above information, in some embodiments, identification of a collaborative asset during the step 128 may include obtaining attribute information such as, for example, a description of the collaborative asset and a description of the collaboration audience. A collaboration audience can be or include external customers, suppliers, distributors, business partners or out-sourced employees.

In addition to the above information, in some embodiments, identification of a collaborative asset during the step 128 may include obtaining information such as, for example: (1) the collaboration mode, which is an indication of the medium which two parties use to facilitate an exchange of information; (2) the average number of people within the associated role (e.g., “FINANCE”) who collaborate on the associated process (e.g., “INVOICE COLLECTION”); (3) the number of collaborators its takes to perform one instance of the associated process; (4) the percentage of the collaborator's headcount time that is dedicated to the associated process; (5) the number of instances of the collaboration that are performed during a time period or instance interval; and (6) the length of time it takes to complete one instance of the collaboration. These six factors or attributes may form the basis of a model of productivity and throughput that a particular collaboration delivers to an overall process. Over the course of one process many collaborations may take place, each of which with its own throughput and resulting level of productivity. These factors provide a universal method of expressing the dynamics of collaborative interaction and may reflect the value of a collaborative asset. In addition to the information provided above, in some embodiments the step 128 may include obtain target information regarding a collaborative asset. For example, the step 128 may include obtaining conservative, probable and/or assertive actual estimates or percentage estimates for different aspects of the collaborative asset for use in evaluating the collaborative asset.

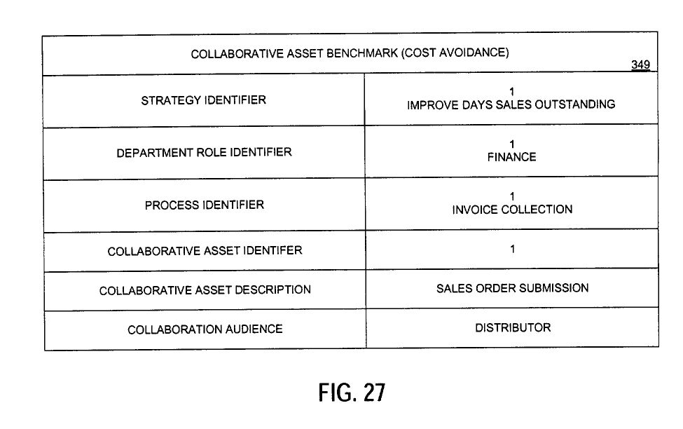

In some embodiments, the step 128 may be implemented via an interface that allows a user to identify or enter one or more collaborative assets and associate them with one or more processes determined during the step 126. For example, an interface or table 349 as illustrated in FIG. 27 may allow a user to enter one or more collaborative assets relative to the process “INVOICE COLLECTION” for the role “FINANCE” and the strategy “IMPROVE DAYS SALES OUTSTANDING” wherein the collaborative asset is a cost avoidance type collaborative asset.

As illustrated in the table 349, a collaborative asset is identified as “SALES ORDER SUBMISSION” and it has a collaborative audience of “DISTRIBUTOR”, which may indicate that a third-party (non-employee audience) is involved in performing a given task or making a given decision.

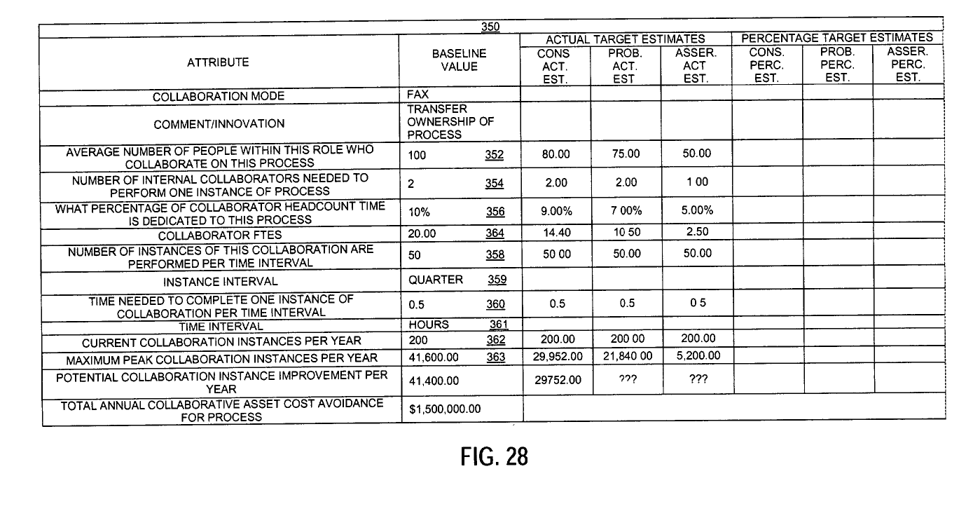

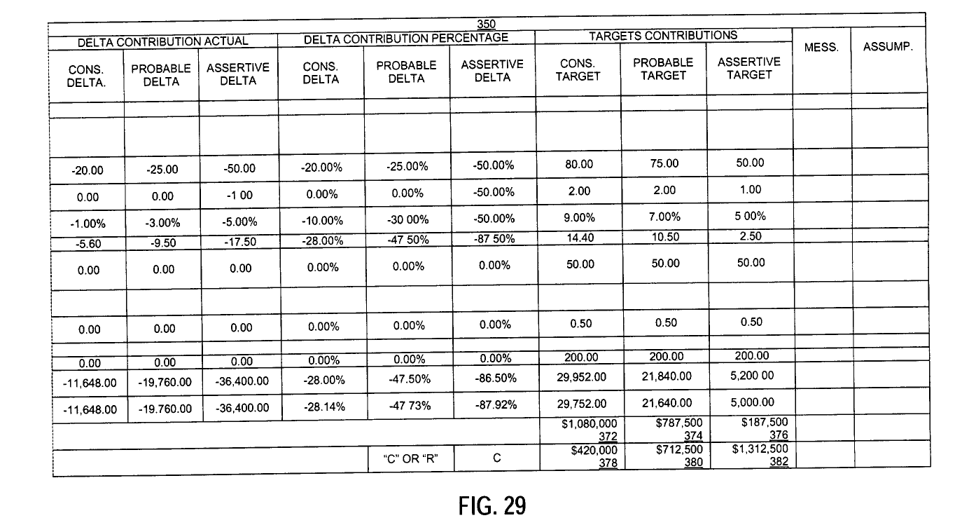

The interface also may allow a user to enter or provide information regarding the collaborative asset “SALES ORDER SUBMISSION”, as illustrated in representative table 350 of FIGS. 28 and 29. The attributes and formulas used in the table 350 are associated with the benchmarking mode selected during the step 102. A different benchmarking mode may use different attributes or formulas for analyzing a collaborative asset.

As shown in the table 350 in FIG. 28, the average number of people outside of the role “FINANCE” who collaborate on the process “INVOICE COLLECTION” is one hundred. The “SALES ORDER SUBMISSION” collaborative asset is a type of cost avoidance, which may indicate that that the collaboration is performed to streamline internal operations, to reduce, eliminate or avoid costs that would normally be incurred by internal employees, but through collaboration the cost is transferred to a third party. This benchmark represented in table 350 models the dynamics of this transfer.

Two collaborators are needed to perform one instance of the collaboration asset “SALES ORDER SUBMISSION”. Ten percent of the collaborator headcount time is dedicated to the process “INVOICE COLLECTION”. Fifty instances of the collaborative asset “SALES ORDER SUBMISSION” are performed every quarter and it takes at last on-half hour to complete one instance of the collaboration.

Also as illustrated in the table 350, several attributes can be computed regarding the collaborative asset “SALES ORDER SUBMISSION”. For example, the number of collaborator full time employees (FTEs) can be computed from entries 352, 354 and 356, is 20.00 (e.g., 20.00=100×2×0.1), and is a measure of full time employees who would be dedicated internally to performing the workload which is being transferred to a third-party or collaborative entity. The current number of collaboration instances per year can be computed from the entries 358 and 359 the instance interval (quarter) and is 200 (e.g., 200=50×4 (quarters per year)). The maximum peak collaboration instances per year can be computed from the entries 360,361, and 364 the duration of an instance and is 41,600.00 (e.g., 0.5 hours (two per hour)×sixteen (assuming an eight hour day)×five days per week×fifty-two weeks per year×twenty collaborator FTEs). The potential collaboration instance improvement per year can be computed from the entries 363 minus the entry 362 (e.g., 41,600−200) and is a measure of maximum productivity improvement feasible for this collaborative asset, given the time and resource constraints given for the collaborative asset. The total annual collaborative asset cost avoidance for the process “INVOICE COLLECTION” can be computed from the entries 364 and the corresponding department role “fully loaded cost of headcount from department” entry 152 (see FIG. 10) and is $1,500,000.00 (e.g., $1,500,000.00=20×$75,000.00) and is a measure of what it would cost internally to perform the collaboration, which is now being performed externally by a third party.

As illustrated in the table 350 in FIG. 28, conservative, probable, and assertive actual target estimates have been entered for various attributes of the collaborative asset “SALES ORDER SUBMISSION”. A user may be prompted, queried or required to provide the target estimate information. The actual target estimates reflect or are a measure of the future or forecasted state of the collaborative asset benchmark attribute. If desired, percentage target estimates could have been used instead of the actual target estimates, as previously discussed above. For example, if the attribute “average number of people within this role who collaborate on this process” had an initial baseline value of “100”, a user may enter conservative, probable and assertive percentage targets of “80%”, “75%” and “50%”, respectively, which would represent the percentage of the entered baseline which would be forecasted for future target levels Now referring to FIG. 29, the conservative, probable, and assertive target estimates in the table 350 of FIG. 28 may be used to generate actual conservative, probable, and assertive delta contributions as well as percentage conservative, probable, and assertive delta contributions, all of which reflect or are a measure of improvements or changes versus the entered baseline values for the model of this collaborative exchange. For example, if one entered “100” for the “average number of people within this role who collaborate on this process” as a baseline value and then entered an actual conservative target value of “80” the resultant delta contribution would be “20%”, where the actual delta contribution would be “20”.

In addition, the conservative, probable, and assertive target estimates entered in table 350 may be used to generate conservative, probable, and assertive target contributions, which reflect or are a measure of the ultimate target values or differences from the established baseline, as previously discussed above.

As illustrated by the entries 372, 374, 376, new target contributions are established using the same formulaic process as in the case of the baseline function. For example, the baseline value TOTAL ANNUAL COLLABORATIVE ASSET COST AVOIDANCE FOR PROCESS or $1,500,000.00 was derived by multiplying the values for entries 364 and 153 (e.g., 20.00×$75,000.00. Each of the conservative, probable and assertive target values can be computed using the same logic but the projected target values rather than the baseline values. Also, as illustrated by the entries 378, 380, 382, target contributions or “net results” are displayed based on whether the benchmark is targeting a cost savings or revenue increase. For a cost savings or avoidance (“C”), the target states (conservative, probable and assertive) are subtracted from the established baseline value “$1,500,000.00). Conversely, for a revenue increase (“R”), the baseline value “$1,500,000.00” is subtracted from each of the target states (conservative, probable and assertive). In both cases the result is reported as the ultimate annual target contribution. This model projects how days sales outstanding (the strategy) can be enhanced if the finance department role collaborated with external parties who are involved in sales order submission and subsequent invoice collection.

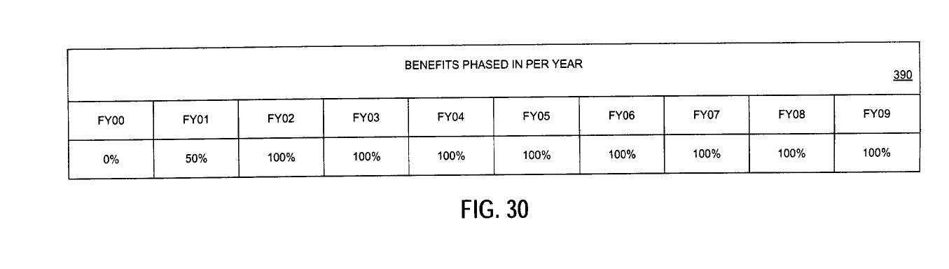

In some embodiments, the interface used in the step 128 also may allow a user to provide or enter information regarding phasing in of the benefits of the collaborative asset described in the table 350 of FIGS. 28 and 29, as illustrated in table 390 in FIG. 30. For the example table 390 for the collaborative asset “SALES ORDER SUBMISSION” process described in the table 350, zero percent of the benefit of the collaborative asset benchmark “SALES ORDER SUBMISSION” will be obtained during the first fiscal year which the collaborative asset is modeled, fifty percent of the benefit of the collaborative asset “SALES ORDER SUBMISSION” will be obtained during the second fiscal year, and one-hundred percent of the benefit of the collaborative asset will be obtained during fiscal years periods, etc. The benefit information provided in table 390 is a reflection or measure of the annual recurrence and extent for which the collaborative asset “SALES ORDER SUBMISSION” makes a contribution to strategy “IMPROVE DAYS SALES OUTSTANDING” and the process “INVOICE COLLECTION” over the lifecycle (years) it is modeled. A user may be prompted or queried to provide the information in the table 338. The table 338 permits phasing in and out of benefits (contributions) commensurate with business objectives and requirements across a period of 1 or more years. Such benefits may be aggregated across all years, roles, at the strategy level, or across all strategies.

While the table 350 illustrates information provided for the collaborative asset “SALES ORDER SUBMISSION” for the process “INVOICE COLLECTION”, the role “FINANCE”, and the strategy “IMPROVE DAYS SALES OUTSTANDING”, other collaborative assets also may be entered for this process, role and strategy in a similar manner.

In some embodiments, different types of collaborative assets may use different formulas/variables as part of the benchmarking process or as part of different benchmarking modes. For example, while the table 350 is particularly well suited for collaborative assets directed to cost avoidance, a different table or interface may be used for collaborative assets directed to value-added service charge. The different table or interface may use different attributes and formulas. A value-added service charge type of collaborative asset is a collaboration for which the enterprise collects revenue from either on a transaction basis or subscription basis. In both the collaborative asset and physical asset benchmarks, there are two different scenarios being modeled, the first being geared for cost-cutting or avoidance, while the second is geared to revenue enhancement.

In some embodiments, identification of a collaborative asset during the step 128 may include obtaining information such as, for example, a description of the collaborative asset and a description of the collaboration audience. In addition to the above information, in some embodiments, identification of a collaborative asset during the step 128 may include obtaining attribute information such as, for example: (1) the estimated average revenue per collaborative value added service; and (2) the estimated average cost savings to vendors or customers per collaborative value added service.

A collaborative asset for value-added service is designed to model the dynamics of transforming information into a value-added service that one could either charge for accessing thus generating revenue, or help the third party avoid their own costs with the enterprise thus locking them into a more loyal relationship. An example of collaborative cost-avoidance is a Web site that provides free access to letter tracking and routing information. Such a Web site this reduces internal costs and makes consumers more loyal as they assume more perceived control. A value-added service collaborative asset benchmark might be a banking Web site which charges for web-based bill payments, a system where a user might be charged a nominal amount each time they submit a check to be paid by the bank. Both of the examples above are indicative of collaborative asset that could be modeled via the benchmarks stated herein.

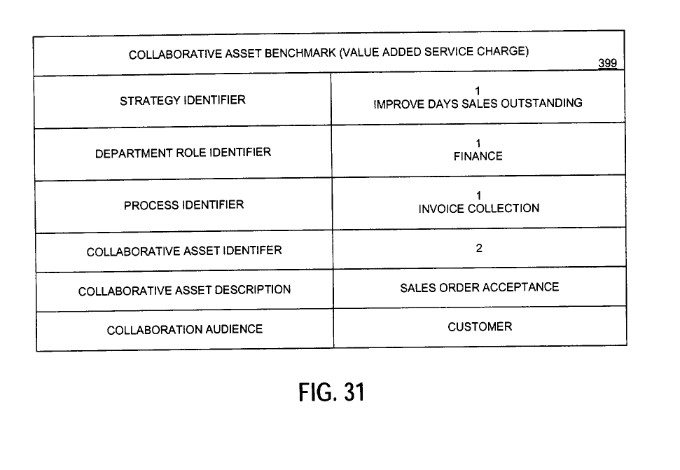

In some embodiments, the step 128 may be implemented via an interface that allows a user to identify or enter one or more collaborative assets and associate them with one or more processes determined during the step 126. For example, an interface or table 399 as illustrated in FIG. 31 may allow a user to enter one or more collaborative assets relative to the process “INVOICE COLLECTION” for the role “FINANCE” and the strategy “IMPROVE DAYS SALES OUTSTANDING” where the collaborative asset is a value added service charge type collaborative asset.

As illustrated in the table 399, a collaborative asset is identified as “SALES ORDER ACCEPTANCE”. The “SALES ORDER ACCEPTANCE” collaborative asset is a type of value added service charge asset, which may indicate that revenue is being collected as an incremental service charge for confirming sales order acceptance. The “SALES ORDER ACCEPTANCE” collaborative asset has a collaboration audience of “CUSTOMER”, which may indicate that a non-employee is relied upon to facilitate the performing a task or making a decision.

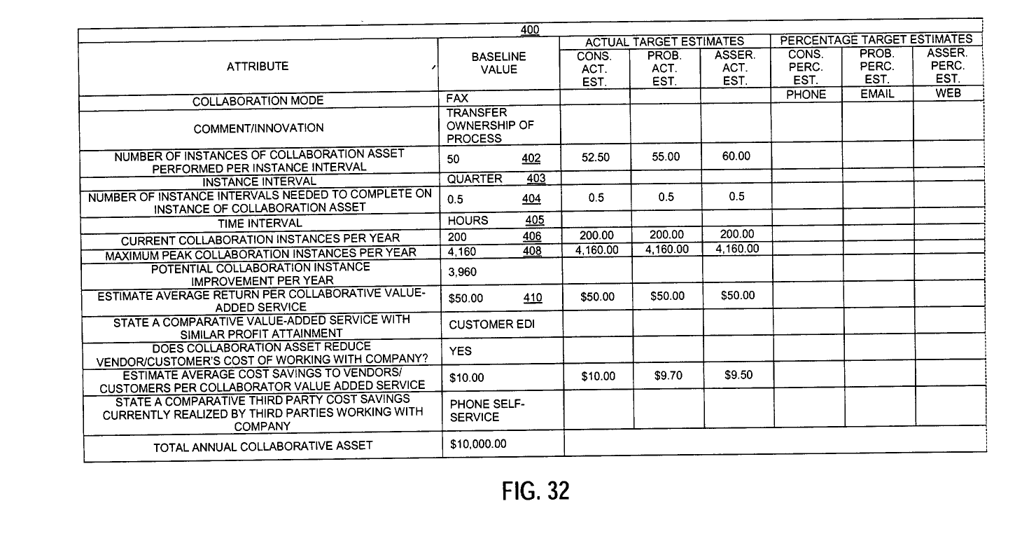

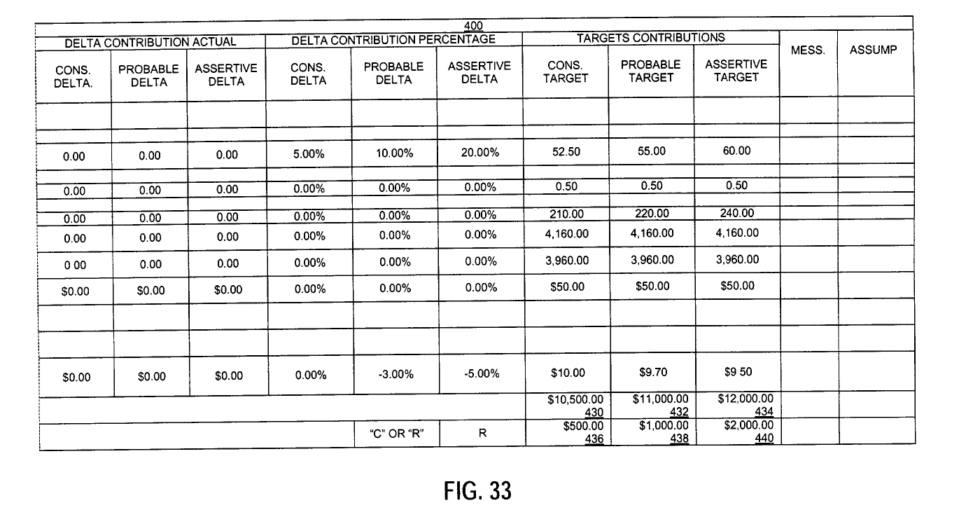

The interface also may include a table 400 as illustrated in FIGS. 32 and 33 that allow a user to provide or enter additional attribute information regarding the collaborative asset “SALES ORDER ACCEPTANCE”. The user may be queried or prompted to provide the attribute information. As illustrated in FIG. 32, fifty instances of the collaborative asset “SALES ORDER ACCEPTANCE” are performed each quarter and it takes approximately one-half hour to complete one instance of the collaborative asset “SALES ORDER ACCEPTANCE”. The average revenue per collaborative value-added service is fifty dollars and the estimated average cost savings to vendors and customers per collaborative value added service is ten dollars.

Also as illustrated in the table 400, several variables can be computed regarding the collaborative asset “SALES ORDER ACCEPTANCE”. For example, the current collaborative asset instances per year can be computed from the entries 402 and a multiplier determined by the instance interval established in entry 403 and extrapolated for a year, is 200 (e.g., fifty×four quarters in one year) and is a measure of how often the current collaborative asset is performed per year. The maximum peak collaboration asset instances per year 408 can be computed from the entries 404 and 405, extrapolated once again for an entire year, is 2,080 (e.g., 2,080=0.5 per hour×sixteen times per day (assuming an eight hour day)×five days per week×fifty-two weeks per year) and is a measure of the peak collaborations possible given the aforementioned constraints. The potential collaboration asset instance improvement per year can be computed from the entries 406 and 408, is equal to 1,880 (e.g., 1,880=2,080−200) and is a measure of the range of possible improvement values of the frequency which collaborations may take place. The total annual collaborative asset revenue for the process “INVOICE COLLECTION” can be computed from the entries 406 and 410, is $10,000.00 (e.g., $10,000.00=200×$50.00), and is a measure of the amount of additional revenue that the collaborative asset “SALES ORDER ACCEPTANCE” benchmark has modeled for the given constraints.

As illustrated in the table 400 in FIG. 32, conservative, probable, and assertive actual target estimates have been entered for various attributes of the collaborative asset “SALES ORDER ACCEPTANCE”. A user may be prompted or queried to provide the target estimate information. The actual target estimates reflect or are a measure of the future or forecasted state of the collaborative asset benchmark attribute. If desired, percentage target estimates could have been used instead of the actual target estimates and in rarely, if ever, will actual target estimates and percentage target estimates be used simultaneously.

Now referring to FIG. 33, the conservative, probable, and assertive target estimates in the table 400 in FIG. 32 may be used to generate actual conservative, probable, and assertive delta contributions as well as percentage conservative, probable, and assertive delta contributions, all of which reflect or are a measure of improvements or changes versus the entered baseline values for the model of this collaborative exchange modeled in the table 400. For example, if one entered “50” for the “number of instances of collaboration asset performed per instance interval” as a baseline value and a then entered an actual probable target actual value of “55” the resultant delta probable contribution would be “10%”, where the actual delta probable contribution would be “5”. In addition, the conservative, probable, and assertive target estimates are used to generate conservative, probable, and assertive target contributions, which reflect or are a measure of the ultimate target values or differences from the established baseline, as previously discussed above.

As illustrated by the entries 430, 432, 434, new target contributions are established using the same formulaic process as in the case of the baseline function. For example, the baseline TOTAL ANNUAL COLLABORATION ASSET with a value of $10,000 is derived by multiplying values for the entries 406 and 410 (e.g., 200×$50.00). Likewise each of the conservative, probable and assertive target values can be computed using the same logic and the respective projected target value versus baseline. Also, as illustrated by the entries 436, 438, 440, target contributions or “net results” are displayed based on benchmarking a revenue increase. For a revenue increase (“R”), the baseline value “$10,000.00” is subtracted from each of the target states (conservative, probable and assertive). The result may be aggregated at the role or strategy levels as well as aggregated across strategies, thereby providing opportunities to analyze financial impact of a particular benchmark and the change in role behavior or impact of a given strategy.

As illustrated in the table 400 in FIG. 33, in some embodiments the table 400 may allow a user to enter or provide information regarding messages or assumptions made or used when entering some of the information in the table 400.

The interface used during the step 128 also may allow a user to provide or enter information regarding phasing in of the benefits of the COLLORABATIVE asset “SALES ORDER ACCEPTANCE” over multiple years,

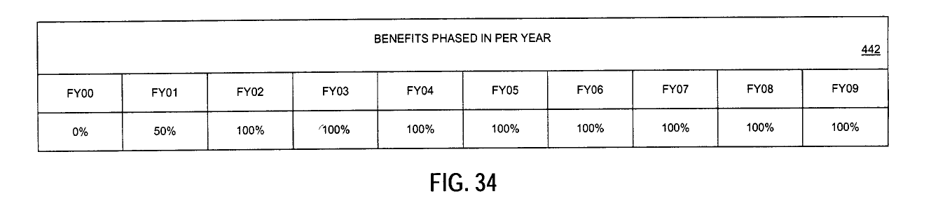

As illustrated in table 442 in FIG. 34. For the example table 442 for the collaborative asset “SALES ORDER ACCEPTANCE” described in the tables 399 and 400, zero percent of the benefit of this modeling of a collaborative asset will be obtained during the first fiscal year, fifty percent of the benefit of the collaborative asset contribution will be obtained during the second fiscal year, one hundred percent of the benefit of the benchmark will be obtained during all subsequent years which are modeled, etc. The benefit information provided in table 442 is a reflection or measure of the annual recurrence and extent for which the collaborative asset “SALES ORDER ACCEPTANCE” makes a contribution to the strategy “IMPROVE DAYS SALES OUTSTANDING” and the process “INVOICE COLLECTION” over the lifecycle (years) it is modeled. A user may be prompted or queried to provide the information in the table 442. Conservative, probable and assertive target contribution values may be phased in by year as a percentage. Table 442 exemplifies how these benefits can be phased in by part or whole, as one-time benefits or as recurring benefits. Table 442 enables one to distribute benefits across multiple years for later aggregation at the role, strategy and across strategies.

The model now contains all relevant information to forecast conservative, probable and assertive target values as weighted by the annual percentages associated to each target values. These target values can be graphed, displayed, reported or further analyzed using standard economic formulas such as return on investment (ROI), net present value (NPR), internal rate of return (IRR), modified internal rate of return (MIRR), earnings per share (EPS), economic value add (EVA), as well as many other types of analysis. Determining and extrapolating recurring annual benefits enable any of these formulas to be exercised.

Given the above organization model, there were two strategies determined at the onset and they were described as “IMPROVE DAYS SALES OUTSTANDING” and “ATTRACT, RETAIN AND DEVELOP CUSTOMERS” respectively 80. For the purpose of this explanation of the present invention, the first strategy “IMPROVE DAYS SALES OUTSTANDING” was examined and discussed in detail. In some embodiments, there is no limit on the number of strategies that may be associated with a particular organizational model.

For strategy 1 “IMPROVE DAYS SALES OUTSTANDING”, a role “1” identified as “FINANCE” 150 was identified and associated with the strategy by the user, based on knowledge of how the organization operates. Reference models can also be automatically accessed from the system and roles may be automatically obtained based on typical organization models related to the industry of participation (e.g., Manufacturing and Finance). For the purpose of this filing, only one role “FINANCE” was completed, although in some embodiments there is no limit on the number of roles that may be associated with a particular strategy.

For role “1” identified as “FINANCE”, a process benchmark “INVOICE COLLECTION” 169, 170 and 198 was identified and associated with the role by the user, based on knowledge of how the organization operates. Reference models can also be automatically accessed from the system and process benchmarks may be automatically obtained based on typical organization models related to the process for the role (e.g., Finance and Orders). For the purpose of this filing, only one process benchmark was discussed in detail, although it should be noted that in some embodiments there is no limit on the number of process benchmarks that may be associated with a particular role.

For the process benchmark 169, 170 and 198 “INVOICE COLLECTION” improvements forecasted in the conservative, probable and assertive actual target estimates would yield a cost savings found in the conservative, probable and assertive target contribution columns 192, 194 and 196 on FIG. 13 of $178,500.00, $221,250.00 and $251,250.00 respectively. The conservative, probable and assertive target contributions may be phased in on an annual basis using the “BENEFITS PHASED IN BY YEAR” grid 198 FIG. 14. Since FY00 has a benefit phase in of zero percent, one would achieve no benefit for the first year of the modeled process improvement (e.g., 0%×$178,500=$0). However for subsequent years, FY01 to FY09 percentages vary from fifty percent to one hundred percent, designating that the “INVOICE COLLECTION” process improvement is a recurring benefit. The conservative target contribution 192 with a value of $178,500.00 would be multiplied by the FY01 benefit phase in value of fifty percent to yield a conservative FY01 contribution of $89,250.00, where the probable target contribution 194 with a value of $221,250.00 would a probable contribution of $110,625.00 for the same period. This phasing in of benefits would occur for all target contributions, across all phase in periods for every process benchmark.

In addition to the process benchmark 169, 170, and 198 “INVOICE COLLECTION”, there are four benchmarks that are associated with the process benchmark. They include a DIGITAL ASSET BENCHMARK 199, 200, and 238 (see FIGS. 15, 16, 17, and 18); a PHYSICAL ASSET BENCHMARK (PROPERTY, PLANT AND EQUIPMENT) 249, 250, and 296 (see FIGS. 19, 20, 21, and 22); a PHYSICAL ASSET BENCHMARK (PRODUCTS FOR SALE AND INVENTORY) 299, 300, and 338 (see FIGS. 23, 24, 25, and 26); a COLLABORATIVE ASSET BENCHMARK (COST AVOIDANCE) 349, 350 and 390 (see FIGS. 27, 28, 29 and 30) and a COLLABORATIVE ASSET BENCHMARK (VALUE ADDED SERVICE CHARGE) 399, 400, and 442 (see FIGS. 31, 32, 33, and 34). Each of these benchmarks represent digital, physical and collaborative (people outside the organization such as contractors, customers, distributors) assets which are impacted by the process benchmark 169, 170, and 198 detailed above. As with the process benchmark, each of the digital, physical and collaborative asset benchmarks also yield conservative, probable and assertive target contributions which can be phased in via their respective BENEFITS PHASED IN PER YEAR schedule.

Conservative, probable and assertive target contributions can be aggregated across all benchmarks for a given role by year for example the probable contribution for the a process benchmark and related digital asset(s), physical asset(s) and collaborative asset(s) can be totaled for the period FY01 and referenced as a department role 150 benefit model. Additionally, all department role benefits can be aggregated by year and referenced as a strategy 80 benefit model. And finally, all strategy benefits can be aggregated by year (e.g., FY00−FY09) and referenced as an organizational benefit model.

Process, digital asset, physical asset, and collaborative asset benchmarks can be summed or aggregated across all strategies, for a particular strategy or for a particular role. Additionally such aggregation would be performed for conservative, probable and assertive values. Such aggregation enables the formulation of ROI (return on investment), NPV (net present value), IRR (internal rate of return), MIRR (modified internal rate of return), simple cash flow and other economic impact reports. Since the example discussed in detail above includes one strategy and one role, the aggregation of benefits is depicted in its simplest form, since the aggregate benefits for the strategy “IMPROVE DAYS SALES OUTSTANDING” (see FIG. 10) and the role “FINANCE” (see FIG. 10) would have the same aggregate values for all six benchmarks types: process benchmark (see FIGS. 11-14); digital asset benchmark (see FIGS. 15-18); physical asset benchmarks (property plant and equipment) (see FIGS. 19-22); physical asset benchmarks (products for sale and inventory) (see FIGS. 23-26); collaborative asset benchmarks (cost avoidance) (see FIGS. 27-30); and collaborative asset benchmark (value added service charge) (see FIGS. 31-34).

For the strategy “IMPROVE DAYS SALES OUTSTANDING” and the role “FINANCE”, the conservative target contribution for the process “INVOICE COLLECTION” is $178,500.00 (see FIG. 13), the conservative target contribution for the digital asset “ESS” is $2,720.00 (see FIG. 17), the conservative target contribution for the physical asset “COLLATOR” is $1,001.00 (see FIG. 21), the conservative target contribution for the physical asset “PC LAPTOP” is $0.00 (see FIG. 25), the conservative target contribution for the collaborative asset “SALES ORDER SUBMISSION” is $420,000.00 (see FIG. 29), and the conservative target contribution for the collaborative asset “SALES ORDER ACCEPTANCE” is $500.00 (see FIG. 33). Thus, the total conservative target contributions to the benefit of ownership provided by all of the assets for the strategy “IMPROVE DAYS SALES OUTSTANDING” and the role “FINANCE” is $424,221.00 (e.g., $424,221.00=$2,720.00+$1,001.00+$0.00+$420,000.00+$500.00). Similar totals can be computed for the total probable target contributions and the total assertive target contributions to the benefit of ownership provided by the assets. The total conservative target contributions provided by the process “INVOICE COLLECTION” and the assets for the benefit of ownership for the strategy “IMPROVE DAYS SALES OUTSTANDING” and the role “FINANCE” is $602,721.00 (e.g., $602,721.00=$178,500.00+$2,720.00+$1,001.00+$0.00+$420,000.00+$500.00). Similar totals can be computed for the total probable target contributions and the total assertive target contributions provided by the process and the assets for the benefit of ownership.

The organization model or example discussed above has one Strategy “1” (IMPROVE DAYS SALES OUTSTANDING), therefore the model-level TBO is $602,721. Since the model has one strategy (e.g., “IMPROVE DAYS SALES OUTSTANDING”), the strategy level TBO also is $602,721.00. Since the strategy “IMPROVE DAYS SALES OUTSTANDING” has one role (e.g., “FINANCE:), the role-level TBO also is $602,721.00. If the model or example had multiple strategies than the model-level TBO would reflect the additional contribution by the additional strategies. Likewise if strategy “IMPROVE DAYS SALE OUTSTANDING” had additional roles, then the strategy-level TBO would reflect the additional contribution from modeling and analysis of the other roles.

Determining a Cost of Ownership for a Strategy

Referring once again to FIG. 1, as previously discussed above during the step 56 a cost of ownership (TCO) may be determined regarding the one or more strategies determined during the step 52. In a typical cost of ownership analysis, a cost model for all life cycle costs associated with implementing such strategy or strategies is determined. In some embodiments, the cost model may include the costs of evaluation, acquisition, implementation, operation usage, maintenance and management of assets needed for such strategy or strategies. In addition, determining a cost of ownership may include a comparison of implementation options (e.g., build versus purchase of equipment) and may look at various cost categories such as hardware costs, software costs, labor costs, travel costs, training costs, etc. needed to implement the strategy or strategies. Thus, the cost of ownership for a strategy is an attempt to quantify the financial impact of implementing the strategy. Costs are computed as incremental investments and are not weighed against any benefits which may be derived from incurred the incremental costs. The TCO for a strategy, role, process, or asset off-sets the benefit(s) of ownership for the strategy, role, process or asset as outlined above by reducing the benefits by the amount of cost which must be incurred by stage of the project and as those stages coincide with the fulfillment of benefits (typically measured by year). For instance if the first year's cost for a strategy is $10,000 and the first year's benefit for the strategy is $100,000, one would realize a positive cash flow of $90,000 or a one thousand percent return on investment.

In some embodiments, different assets may be associated with more than one strategy. For example, a server or computer needed in the implementation of a first strategy may have enough capacity to be used in the implementation of a second strategy. The cost of ownership for the server may be apportioned between the two strategies. For example, the cost of ownership for the server may be apportioned in the ratio percentages as the benefits provided by the server to the two strategies.

In some embodiments, it may be difficult to determine the cost of ownership for individual roles, assets and/or processes associated with a strategy and/or to allocate the cost of ownership for a strategy across the roles, processes and assets associated with the strategy. In such cases, the cost of ownership for a strategy may be allocated among the different roles associated with the strategy in accordance with the respective benefit of ownership provided by or associated with the roles. For example, a process benchmark 169 and 170 may yield a negative conservative, probable and assertive target contribution 192, 194 and 196 respectively. This negative contribution would be interpreted by the model as a negative benefit or increased cost. The same characteristic holds true for the digital asset benchmark, physical asset benchmarks, collaborative asset benchmarks which may introduced into the model. Negative contributions can be aggregated to the role level or to the strategy level providing a total cost of ownership across all strategies, a given strategy, all roles, all roles within a strategy or a given role.

As one example of a total cost of ownership that may be associated with or determined for the strategy “IMPROVE DAYS SALES OUTSTANDING” previously discussed above, one might have to introduce a new DIGITAL ASSET to enable the benefits detailed by the “ESS” DIGITAL ASSET. The new DIGITAL ASSET “ESS SOFTWARE” 199 and 200 would have baseline values of zero designating that they were not present at the initial state of modeling. Actual or percentage conservative, probable and assertive targets would have a positive value designating the introduction of the asset at some future state of the model, and thus produce negative conservative, probable and assertive target contributions 232, 234 and 236. Negative contributions would be aggregated for fiscal time period, role and strategy.

Facilitating Evaluation of a Strategy

Referring once again to FIG. 1, as previously discussed above during the step 58 an evaluation of the strategy or strategies determined during the step 52 is facilitated. In some embodiments, an evaluation or review of a strategy or strategies may be facilitated or based on the benefit of ownership determined during the step 54 for such strategy or strategies and the cost of ownership determined during the step 56 for such strategy or strategies. In some embodiments, the step 58 may be optional and not used.

In some embodiments, the benefit of ownership for a strategy determined during the step 54 and the cost of ownership for the strategy determined during the step 56 may be used to determine additional information regarding the strategy such as, for example, the internal rate of return for the strategy, a modified internal rate of return for the strategy, the return on investment for the strategy, total competitive potential of ownership for the strategy, etc. For example, the internal rate of return (IRR) for a strategy may be determined by establishing the interest rate that makes net present value of all cash flow equal zero. All aggregated target contributions (conservative, probable or assertive) from the benefit of ownership minus the cost of ownership for the given strategy, role or process produces a number of cash flows over time. The internal rate of return is defined to be the discount rate that makes the net present value of those cash flows equal to zero. Essentially this is the return that a company would earn if they expanded or invested in themselves rather than investing that money.

A modified internal rate of return (MIRR) for a strategy may be determined by establishing the internal rate of return for the strategy adjusted for negative cash flows using a “safe rate” to provide for future negative cash flows (e.g., all aggregated target contributions (conservative, probable or assertive) from the benefit of ownership minus the cost of ownership for the given strategy, role or process produces a number of cash flows over time, where the MIRR assumes that all cash flows are reinvested at the firm's cost of capital).

The return on investment (ROI) for a strategy may be determined by establishing the profit or loss resulting from an investment transaction, usually expressed as an annual percentage return (e.g., all aggregated target contributions (conservative, probable or assertive) from the benefit of ownership minus the cost of ownership for the given strategy, role or process produces a number of cash flows over time, and dividing these cash flows by their corresponding costs over time yield a ratio known as ROI).

In some embodiments, the step 58 or the method 50 may include determining an internal rate of return for a strategy, a modified internal rate of return for a strategy, the return on investment for a strategy, total competitive potential of ownership for a strategy, etc.

In some embodiments, an EBITDA (earnings, before interest, taxes, depreciation, and amortization) hurdle rate may be determined for a strategy. An EBITDA hurdle rate for a strategy is an indication of how many dollars of earnings before interest, taxes, depreciation and amortization is required to free a dollar that may be applied to a project as an expense. An EBITDA hurdle rate for a strategy may be determined by dividing EBITDA for a given period by Revenue for the same given period provides a ratio of how many dollars of revenue must be generated to incur one dollar of EBITDA which may be dedicated to the expense of a new project. An EBITDA hurdle rate for a strategy may be used to provide an alternative ratio to compare and contrast the magnitude and acceptability of an ROI. In some embodiments, a NOPAT (net operating profit after taxes) hurdle rate may be determined for a strategy. A NOPAT hurdle rate for a strategy is an indication of how many dollars of Revenue is required to free a dollar of NOPAT that may be applied to a project as an expense. A NOPAT hurdle rate for a strategy may be determined by dividing NOPAT for a given period by Revenue for the same given period. A NOPAT hurdle rate for a strategy may be used to provide an alternative ratio to compare and contrast the magnitude and acceptability of an ROI. In some embodiments, the step 58 or the method 50 may include determining an EBITDA hurdle rate and/or a NOPAT hurdle rate for one or more strategies.

In some embodiments, the evaluation facilitated during the step 58 may include providing some or all of the information determined during the steps 52, 54, and 56 to another party or device for review. Such review may include analyzing the methodologies, techniques, benchmarking modes, targets, attributes, variables and/or formulas used or identified during the steps 52, 54, 56 and providing comments, suggestions, or corrections regarding same.

In some embodiments, the evaluation facilitated during the step 58 may include providing some or all of the information determined during the steps 52, 54, 56 to one or more people within an organization for comment. In addition, the evaluation may determine overall or detailed impressions of a participant's assessment of a strategy and the benefit of ownership and/or cost of ownership computed for the strategy. The people may be organized or categorized into different business roles for purposes of the evaluation. A business role for a person is indicative the impact a proposed strategy may have on the person. For example, an organization may assign a business role to each person within the organization with regards to a strategy. Business roles may be or include: analyst, impactant, champion/sponsor, and implementer. An analyst for a particular strategy may be defined as someone who analyzes the merits of the strategy. An impactant for a particular strategy may be defined as someone who is directly impacted or affected by implementation of a strategy. For example, a sales professional may be the impactant of a strategy to attract, retain and develop customers but may not be the implementer, sponsor/champion or analyst for the strategy. A champion/sponsor for a particular strategy may be defined as someone who fund, lead, and/or spearhead a strategy. An implementer for a particular strategy may be defined as someone who is responsible for all or a portion of implementing the strategy.

A person may be in organization model role for a project and in a different business role for the same project. For example, for one project a user may have the “Department Role” of Sales and the organizational role of “Analyst”. In some embodiments, the step 58 or the method 50 may include classifying or organizing one ore more people into a set of business roles for one or more strategies, determining the set of business roles for people associated with a strategy or organization, etc.

In addition to being identified with a business role, in some embodiments some or all of the people within an organization may be organized or categorized into one or more department roles for purposes of the evaluation. A department role for a person may be indicative of the person's job responsibility. For example, different department roles within an organization may be or include: sales, marketing, executive, customer support, manufacturing, etc. In some embodiments, the step 58 or the method 50 may include classifying or organizing one ore more people into a set of department roles for one or more strategies, determining the set of department roles for people associated with a strategy or organization, etc.

Once a group of people are organized or categorized into different business roles and/or department roles, the people may be queried regarding the strategy determined during the step 52, the benefit of ownership for the strategy determined during the step 54, and/or the cost of ownership for the strategy determined during the step 56. Different people in different business roles or department roles may be asked different questions regarding the strategy determined during the step 52, the benefit of ownership for the strategy determined during the step 54, and/or the cost of ownership for the strategy determined during the step 56. For example, people may be asked to rate their willingness to participate in one or more changes associated with a strategy, rate their expectation of a successful implementation of a strategy, rate their perception of the magnitude of the benefit associated with a strategy, rate their perception of the magnitude of the cost associated with a strategy, etc. As another example, the people may be asked the same questions with particular regard to a specific process that underlies or is associated with a strategy.

In some embodiments, the step 52 or the method 50 may include sending a communication to, and/or receiving a response from, one or more people regarding a strategy or process, a benefit of ownership associated with a strategy or process, a cost of ownership associated with a strategy or process, etc. Such a communication or response may be sent in or via one or more of a variety of formats or delivery channels. For example, the communication may be or include an email message, facsimile transmission, beeper or pager signal, HTML request, XML or FTP transmission, instant message communication, telephone or radio signal, or other electronic transmission.

Responses to the questions can be analyzed and used to determine which groups of people may have a consensus regarding one or more aspects (e.g., its cost of implementation, its expected benefit) of a strategy, which groups of people may have doubts or disagreement regarding assumptions underlying a strategy, a benefit of ownership associated with a strategy determined during the step 54 and/or a cost of ownership associated with a strategy determined during the step 56, etc. Such results may be tabulated by business role and/or by department role. For example, users who have the organization model role of “Analyst” may rate a strategy as being too costly or too hard to implement, while users who have a department role of sales (some of which may also be “Analysts” may rate a the same strategy as being fairly costed and highly implementable.

In some embodiments, the step 52 or the method 50 may include tabulating or determining results from one or more questions sent to one or more people regarding one or more strategies or aspects of the one or more strategies. The questions provide qualitative input that substantiates the quantitative financials delivered by the model. Questions may include queries on costs, benefits, ability to implement, willingness to participate, and other aspects that provide a context to the organization model.

System

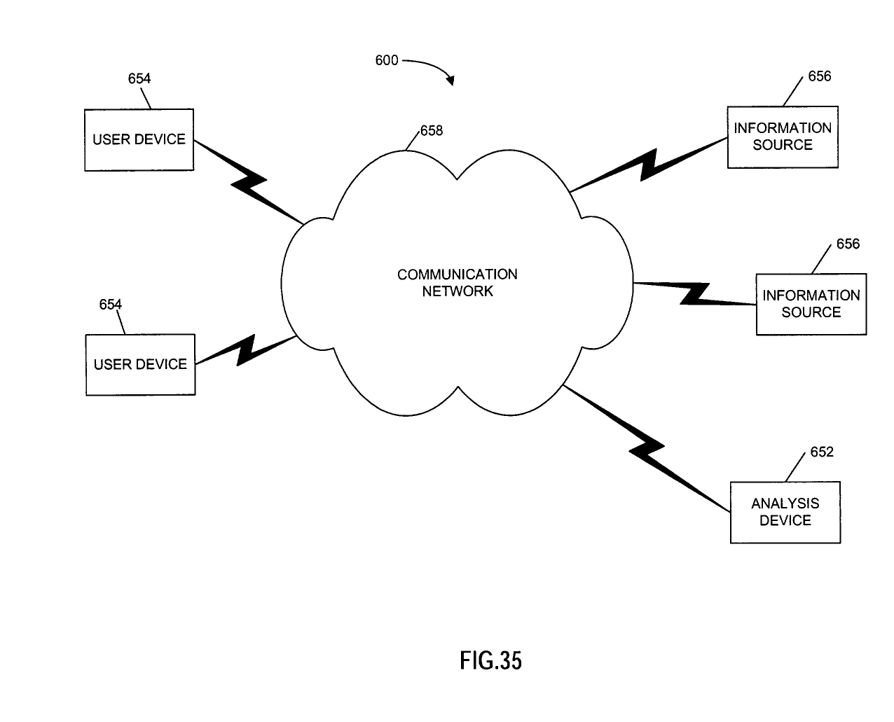

Now referring to FIG. 35, an apparatus or system 600 usable with the methods disclosed herein is illustrated. The apparatus 600 may include an analysis device 652 useful in implementing some or all of the methods disclosed herein as well as one or more user or client devices 654 that may communicate directly or indirectly with the analysis device 652 and/or other devices, and one or more information sources 656. The devices may communicate via a computer, data, or communications network 658. Many different types of implementations or hardware configurations can be used in the system 600 and with the methods disclosed herein and the methods disclosed herein are not limited to any specific hardware configuration for the system 600 or any of its components.

For purposes of further explanation and elaboration of the methods disclosed herein, the methods disclosed herein will be assumed to be operating on, or under the control of, the analysis device 652. In some embodiments, however, some or all of the methods disclosed herein may be implemented on or by a user device 654.

In some embodiments, the analysis device 652 may implement or host a Web site. The analysis device 652 can comprise a single device or computer, a networked set or group of devices or computers, a workstation, etc.

The user or client devices 654 preferably allow entities to interact with the analysis device 652 and the remainder of the apparatus 600. The user devices 654 also may enable a user to access Web sites, software, databases, etc. hosted or operated by the analysis device 652. If desired, the user devices 654 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

In some embodiments, an information source may be or include a web site, database, library, government agency (e.g., the Securities and Exchange Commission), private company (e.g., Dun and Bradstreet), etc. from which information may be located, obtained or retrieved. For example, financial data may be transferred to the application via an XML feed over the World Wide Web or may be analyzed using a local database. In some embodiments, an information source may refer to data that can be transformed or exists in a digital medium including: transaction data, documents, pictures, XLM feeds, EDI transfers, data from off-line storage systems such as tape and optical disks, etc.

The communications network 658 might be or include the Internet, the World Wide Web, or some other public or private computer, cable, telephone, client/server, peer-to-peer, or communications network or intranet, as will be described in further detail below. The communications network 658 illustrated in FIG. 35 is meant only to be generally representative of cable, computer, telephone, peer-to-peer or other communication networks for purposes of elaboration and explanation of the present invention and other devices, networks, etc. may be connected to the communications network 658 without departing from the scope of the present invention. The communications network 658 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. In some embodiments, a user device may be connected directly to the analysis device 652 without departing from the scope of the present invention. Moreover, as used herein, communications include those enabled by wired or wireless technology.

Analysis Device

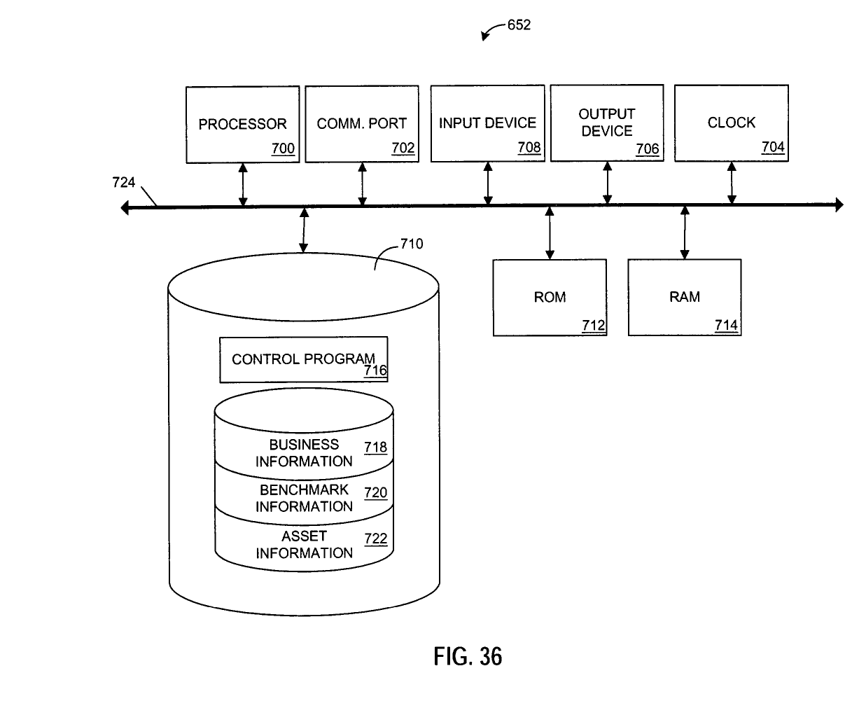

Now referring to FIG. 36, a representative block diagram of the analysis device 652 is illustrated. The analysis device 652 may include a processor, microchip, central processing unit, or computer 700 that is in communication with or otherwise uses or includes one or more communication ports 702 for communicating with user devices and/or other devices. Communication ports may include such things as local area network adapters, wireless communication devices, Bluetooth technology, etc. The analysis device 700 also may include an internal clock element 704 to maintain an accurate time and date for the analysis device 652, create time stamps for communications received or sent by the analysis device 652, etc. In some embodiments, the analysis device 652 may comprise or include a single computer, a computer system, a distributed system or other configuration. The term “analysis device” is used herein solely for the purpose of convenience and no specific limitation(s) is intended or implied by the used of the term “analysis device”.

If desired, the analysis device 652 may include one or more output devices 706 such as a printer, infrared or other transmitter, antenna, audio speaker, display screen or monitor, text to speech converter, etc., as well as one or more input devices 708 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the analysis device 652 may include a memory or data storage device 710 to store information, software, databases, communications, device drivers, benchmark variables, benchmark formulas, libraries, etc. The memory or data storage device 710 may comprise or include an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The analysis device 652 also may include separate ROM 712 and RAM 714.

The processor 700 and the data storage device 710 in the analysis device 652 each may be, for example: (i) located entirely within a single computer or other computing device; or (ii) connected to each other by a remote communication medium, such as a serial port cable, telephone line or radio frequency transceiver. In one embodiment, the analysis device 652 may comprise one or more computers that are connected to a remote server computer for maintaining databases.

A conventional personal computer or workstation with sufficient memory and processing capability may be used as the analysis device 652. In one embodiment, the analysis device 652 operates as or includes a Web server for an Internet environment. The analysis device 652 may be capable of high volume transaction processing, performing a significant number of mathematical calculations in processing communications and database searches. A Pentium™ microprocessor such as the Pentium IV™ microprocessor, manufactured by Intel Corporation may be used for the processor 700. Equivalent processors are available from Motorola, Inc., AMD, or Sun Microsystems, Inc. The processor 700 also may comprise one or more microprocessors, computers, computer systems, etc.

Software may be resident and operating or operational on the analysis device 652. The software may be stored on the data storage device 710 and may include a control program 716 for operating the server, databases, etc. The control program 716 may control the processor 700. The processor 700 may performs instructions of the control program 716, and thereby operates in accordance with the present invention, and particularly in accordance with the methods described in detail herein. The control program 716 may be stored in a compressed, uncompiled and/or encrypted format. The control program 716 furthermore includes program elements that may be necessary, such as an operating system, a database management system and device drivers for allowing the processor 700 to interface with peripheral devices, databases, etc. Appropriate program elements are known to those skilled in the art, and need not be described in detail herein.

The analysis device 652 also may include or store information regarding users, user devices, content segments, benchmark variables, benchmark formulas, companies, communications, etc. For example, information regarding one or more companies or other organizations may be stored in an organization information database 718 for use by the analysis device 652 or another device or entity. Information regarding one or more benchmarks may be stored in a benchmark information database 720 for use by the analysis device 652 or another device or entity and information regarding one or more assets may be stored in an asset information database 722 for use by the analysis device 652 or another device or entity. In some embodiments, some or all of one or more of the databases may be stored or mirrored locally or remotely from the analysis device 652.

According to an embodiment of the present invention, the instructions of the control program 716 may be read into a main memory from another computer-readable medium, such as from the ROM 712 to the RAM 714. Execution of sequences of the instructions in the control program causes the processor 700 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 700, communication port 702, clock 704, output device 706, input device 708, data storage device 710, ROM 712, and RAM 714 may communicate or be connected directly or indirectly in a variety of ways. For example, the processor 700, communication port 712, clock 714, output device 716, input device 718, data storage device 710, ROM 712, and RAM 714 may be connected via a bus 724.

While specific implementations and hardware configurations for the analysis device 652 have been illustrated, it should be noted that other implementations and hardware configurations are possible and that no specific implementation or hardware configuration is needed. Thus, not all of the components illustrated in FIG. 36 may be needed for an analysis device implementing some or all of the methods disclosed herein.

User Device

As mentioned above, a user device 654 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device 704 may have the same structure or configuration as the server 652 illustrated in FIG. 36 and include some or all of the components of the analysis device 652.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating analysis of an organization, comprising:
determining a strategy associated with an organization;
determining a benefit of ownership associated with said strategy, wherein said determining a total benefit of ownership associated with said strategy includes determining a role associated with said strategy, a process associated with said role, and at least one asset associated with said process; and
determining a cost of ownership associated with said strategy.

2. The method of claim 1, wherein said determining a strategy associated with an organization includes:
receiving information identifying said organization;
receiving information regarding at least one metric; and
receiving information regarding at least one year of relevance.

3. The method of claim 1, wherein said determining a strategy associated with an organization includes:
determining a plurality of criterion;
determining a plurality of other organizations; and
comparing said organization to said plurality of other organizations based on said plurality of criterion

4. The method of claim 1, wherein said determining a strategy associated with an organization includes:
determining a plurality of criterion;
determining a plurality of other organizations; and
determining a best-in-class among said organization and said plurality of other organizations with regard to at least one of said plurality of criterion.

5. The method of claim 1, wherein said determining a benefit of ownership associated with said strategy includes analyzing said process in accordance with a first benchmark and analyzing said at least one asset in accordance with a second benchmark.

6. The method of claim 5, wherein said analyzing said process in accordance with first benchmark includes determining a base value for at least one attribute associated with said first benchmark and determining a plurality of estimates regarding changes in said attribute as a result of implementation of said process.

7. The method of claim 1, wherein said at least one asset includes one of the following:
a digital asset;
a physical asset; and
a collaborative asset.

8. The method of claim 1, further comprising:
facilitating evaluation of said strategy, said benefit of ownership and said cost of ownership.

9. The method of claim 8, wherein said facilitating evaluation of said strategy, said benefit of ownership, and said cost of ownership includes comparing said benefit of ownership against a previously determined benefit of ownership associated with said strategy.

10. The method of claim 9, wherein said facilitating evaluation of said strategy, said benefit of ownership, and said cost of ownership includes comparing said cost of ownership against a previously determined cost of ownership associated with said strategy.

11. The method of claim 8, wherein said facilitating evaluation of said strategy, said benefit of ownership, and said cost of ownership includes identifying a group of people and assigning each of said group of people to a business role.

12. The method of claim 11, wherein said facilitating evaluation of said strategy, said benefit of ownership, and said cost of ownership includes providing a request to each of said people to answer a set of at least one question.

13. A method for facilitating analysis of an organization, comprising:
determining a strategy associated with an organization; and
determining a benefit of ownership associated with said strategy, wherein said strategy has at least one associated process and said at least one associated process has at least one associated asset.

14. The method of claim 13, further comprising:
facilitating evaluation of said strategy.

15. A method for facilitating review of strategy associated with an organization, comprising:
determining a strategy associated with an organization;
determining a plurality of people associated with said strategy;
determining a first role for each of said plurality of people; and
providing a set of at least one question regarding said strategy to each of said plurality of people.

16. The method of claim 15, wherein said determining a strategy includes determining a role associated with said strategy, determining a process associated with said role, and determining at least one asset associated with said process.

17. A method for facilitating development of benchmark information regarding an organization, comprising:
allowing a user to select a benchmarking mode to analyze an organization;
determining information needed for said benchmarking mode; and
providing information regarding said organization determined as a result of implementing said benchmarking mode.

18. The method of claim 17, wherein said allowing a user to select a benchmarking mode includes allowing said user to selecting a benchmarking mode from among a plurality of benchmarking modes.

19. The method of claim 17, wherein said allowing a user to select a benchmarking mode providing data to a user indicative of a plurality of benchmarking modes and receiving from said user an indication of one of said plurality of benchmarking modes.

20. The method of claim 17, wherein said determining said information regarding said organization includes determining a strategy associated with said organization;

21. The method of claim 20, wherein said determining said information regarding said organization includes determining at least one role associated with said strategy.

22. The method of claim 21, wherein said determining said information regarding said organization includes determining at least one process associated with said role and determining at least one asset associated with said process.

23. The method of claim 17, wherein said determining said information regarding said organization includes determining at least one process associated with said strategy and determining at least one asset associated with said process.

24. A method for determining a benefit of ownership for a strategy, comprising:
determining a strategy associated with an organization;
determining a process associated with said strategy;
determining an asset associated with said process; and
determining a target for at least one attribute of said asset.

25. The method of claim 24, further comprising:
determining a benchmarking mode associated with said strategy, wherein said attribute is associated with said benchmarking mode.

26. A method for determining a benefit of ownership for a strategy, comprising:
determining a strategy associated with an organization;
determining a role associated with said strategy;
determining a process associated with said role;
determining an asset associated with said process; and
determining a target for at least one attribute of said asset.

27. The method of claim 26, wherein said determining a strategy associated with said organization includes at least one of the following:
receiving information indicative of said strategy; and
requesting information regarding said strategy and receiving information indicative of said strategy in response to said request.

28. The method of claim 26, determining a role associated with said strategy includes at least one of the following:
receiving information indicative of said role; and
requesting information regarding said role and receiving information indicative of said role in response to said request.

29. The method of claim 26, wherein said determining a process associated with said role includes at least one of the following:
receiving information indicative of said process; and
requesting information regarding said process and receiving information indicative of said process in response to said request.

30. The method of claim 26, determining an asset associated with said process includes at least one of the following:
receiving information indicative of said asset; and
requesting information regarding said asset and receiving information indicative of said asset in response to said request.

31. The method of claim 26, wherein said determining at least one target for at least one attribute associated with said asset includes at least one of the following:
determining a conservative actual estimate regarding said at least one attribute;
determining a probable actual estimate regarding said at least one attribute;
determining an assertive actual estimate regarding said at least one attribute;
determining a conservative percentage estimate regarding said at least one attribute;
determining a probable percentage estimate regarding said at least one attribute; and
determining an assertive percentage estimate regarding said at least one attribute.

32. The method of claim 26, further comprising:
determining a benefit associated with said target.

33. The method of claim 26, further comprising:
determining a phasing in of a benefit associated with said target.

34. The method of claim 26, further comprising:
determining a benchmarking mode associated with said strategy.

35. The method of claim 26, further comprising:
facilitating evaluation of said strategy.

36. A system for facilitating analysis of an organization, comprising:
a memory;
a communication port; and
a processor connected to said memory and said communication port, said processor being operative to:
determine a strategy associated with an organization; and
determine a benefit of ownership associated with said strategy, wherein said strategy has at least one associated process and said at least one associated process has at least one associated asset.

37. The system of claim 36, wherein said processor is operative to determine a cost of ownership associated with said process.

38. The system of claim 36, wherein said processor is operative to facilitate evaluation of said strategy.

39. A system for facilitating determination of a benefit of ownership of a strategy, comprising:
a memory;
a communication port; and
a processor connected to said memory and said communication port, said processor being operative to:
determine a strategy associated with an organization;
determine a process associated with said strategy;
determine an asset associated with said process; and
determine a target for at least one attribute of said asset.

40. The system of claim 39, wherein said processor is operative to determine a role associated with said strategy.

41. A computer program product in a computer readable medium for facilitating analysis of a strategy, comprising:
first instructions for identifying a strategy associated with an organization; and
second instructions for identifying a benefit of ownership associated with said strategy, wherein said strategy has at least one associated process and said at least one associated process has at least one associated asset.

42. A computer program product in a computer readable medium for facilitating determination of a benefit of ownership of a strategy, comprising:
first instructions for identifying a strategy associated with an organization;
second instructions for identifying a process associated with said strategy;
third instructions for identifying an asset associated with said process; and fourth instructions for identifying a target for at least one attribute of said asset.
